(19) United States
(12) Patent Application Publication
(10) Pub. No.: US 2008/0010186 A1
(43) Pub. Date: Jan. 10, 2008

(54) System and method for internally matching electronic trade orders originated by a preselected group of traders

(75) Inventors: Frank Weimer, Wiesbaden (DE); Dacian Rosca, Frankfurt/Main (DE); Steffen Gemuenden, Chicago, IL (US)

Correspondence Address: Cynthia Smith;RTS Realtime Systems, Inc., Ste. #980, 311 South Wacker Dr., Chicago, IL, 60606, US

(73) Assignee: RTS Realtime Systems Software GmbH, Frankfurt/Main (DE)

(21) Appl. No.: 11/825,453

(22) Filed: Jul. 6, 2007

Related U.S. Application Data
(60) Provisional application No. 60/819,173, filed on Jul. 7, 2006.
(60) Provisional application No. 60/855,887, filed on Nov. 1, 2006.
(60) Provisional application No. 60/927,369, filed on May 2, 2007.

(51) Int. Cl. G06Q 40/00

(52) U.S. Cl. 705/37

(57) ABSTRACT

A system and method for internally matching an electronic trade order originated by a trader of a pre-selected group of traders is provided. The system includes an internal provider server including an internal order matcher function, and a gateway communicatively coupled to the internal provider server and an external host system. The gateway is configured to provide a translation interface between the internal provider server and an external host system, and the internal provider server is configured to match the electronic trade order to another electronic trade order placed by another trader of the pre-selected group of traders.

### CROSS-REFERENCE TO RELATED APPLICATIONS

This application claims benefit under 35 U.S.C. §119(e) of a first U.S. Provisional Application entitled “A System and Method for Internally Executing Electronic Trade Orders Originated by a Pre-selected Group of Traders”, filed on Jul. 7, 2006, having application number U.S. 60/819,173, and a second U.S. Provisional Application entitled “A System and Method for Internally Executing Electronic Trade Orders Originated by a Pre-selected Group of Traders”, filed on Nov. 1, 2006, having application number U.S. 60/855,887, and a third U.S. Provisional Application entitled “A System and Method for Internally Executing Electronic Trade Orders Originated by a Pre-selected Group of Traders”, filed on May 2, 2007, having application number U.S. 60/927,369, the entire contents of which are incorporated herein.

### BACKGROUND OF THE INVENTION

The present invention generally relates to electronic trading, and more specifically, to a system and method for internally matching electronic trade orders originated by a pre-selected group of traders.

Over the past few years, computerized electronic trading of tradable instruments such as stocks/equities, bonds, futures, options, currencies, warrants, commodities, etc., has steadily been replacing traditional open-outcry trading worldwide. In general, such electronic trading of cash and derivatives market products is facilitated using computer networks that include matching engine schemes. The computer networks may be hosted by one or more trading exchanges (e.g., CME, CBOT, EUREX), and may further include communication servers and/or networks, and be communicatively coupled to end-user computers or electronic terminals. Other matching engine schemes that facilitate electronic trading of tradable instruments may include an Alternative Trading System (ATS) such as an Electronic Communication Network (ECN) or a crossing network, to name a few. For ease of discussion, the computer networks hosted by one or more trading exchanges and/or an ATS(s) are herein referred to as “external host systems”, and the end-user computers or electronic terminals are herein referred to as “client terminals”.

Operations provided by an external host system may include maintaining trade order books, facilitating trade order-matching, providing price discovery and market data distribution for the online trading day as well as executing nightly batch runs to process end-of-day tasks such as clearing executed trade orders. The external host system may also be equipped with external interfaces that operate to maintain uninterrupted online contact with quote vendors and other price information systems.

In general, a trade order is an instruction to buy or sell a quantity of a tradable instrument at a selected price or better. A list of trade orders for a particular tradable instrument, or a “trade-order book”, is ranked, for example, by time priority and price. Based on the time priority and prices reflected in the trade order book for the tradable instrument, a trade order is matched with another trade order, and then executed to complete the transaction. The trade order may also be matched to either a buy side or a sell side of a quote, depending on the trade order. After execution, the trade order is cleared by an appropriate clearing entity.

External host systems are typically communicatively coupled to any number of client terminals via one or more suitable interfaces such as external gateways and/or provider server equipment. Among other things, software included with the provider server equipment and the external gateways enables establishment of an electronic trading interface between the external host system and the client terminal(s). For ease of discussion, the users of the client terminals, hereinafter referred to as “traders” may include investment banks, proprietary trading firms, individual traders, hedgefunds, brokers, commodity trading adviser (CTA), market makers/specialists, on-line brokers, corporations, clearing companies and the like.

Traders generally utilize specialized interactive trading screens that are displayed on their client terminals by front-end software. Such front-end software may be provided by trading hardware/software providers (“providers”) such as exchanges, independent software vendors (ISVs), on-line brokers, investment banks, clearing companies, etc. Among other things, the interactive trading screens enable the trader to obtain market data, enter trade orders, cause trade orders to be initiated, and monitor positions (i.e., executed trade orders).

As is known, each external host system (e.g., trading exchange) supplies the same type of information to each trader. Likewise, each external host system requires that each trader provides the same type of information when placing a trade order for a tradable instrument. Bids (orders to buy) and asks (orders to sell) for each tradable instrument received by the external host system form so-called “market data”. In most cases, each logged-on trader has access to this market data. Similarly, every external host system requires that certain trade order information be included with each trade order. For example, a trade order may include the name of the tradable instrument, quantity, order restrictions, price and multiple other variables, to name a few. Without all of the required information, the external host system will not accept and/or match the trade order for execution.

Trader access to the external host system may be enabled using one of any number communications networks, including wired and wireless communication networks, between the client terminal and the external host system. Once access is established, trade order information is formatted into, for example, a packetized “order message” using a suitable protocol for bi-directional transmission between the client terminal and the external host system. Such protocols may include TCP/IP, UDP/IP, X.25, SDLC, or equivalent protocols.

As is known, a number of fees are associated with each completed trade order. For example, a trading fee is typically charged via the external host system for each executed trade order. The trading fees vary, depending on the trader's classification and the type of tradable instrument indicated in the trade order. Clearing fees may also be charged by a “clearing entity” (e.g., CME Clearing House, the Options Clearing Corporation) to clear an executed trade order. Often, an external host system additionally performs a portion of the clearing function and therefore collects a portion of the clearing fees. Such fees charged by an external host system for enabling execution of trade orders and/or clearing executed trade orders may represent a significant cost for the trader. Accordingly, traders are always searching for ways to minimize fees associated with trade order execution and clearing.

Numerous prior art methods have been proposed which enable trade order matching while circumventing some trading and clearing fees charged by an external host. They are, however, costly to implement and typically include functionality beyond what is needed to simply circumvent the trading and clearing fees charged by an external host.

### SUMMARY OF THE INVENTION

In general, a system and method for internally matching electronic trade orders originated by a pre-selected group of traders is provided. In an embodiment, the system includes an internal provider server, an internal order matcher communicatively coupled to the internal provider server, and a gateway communicatively coupled to the internal provider server and an external host system. The gateway is configured to provide a translation interface between the internal provider server and an external host system. The system also includes a client terminal communicatively coupled to the internal provider server. The client terminal enables origination of a first electronic trade order by a first trader of the pre-selected group of traders. The internal order matcher is configured to match the first electronic trade order to a second electronic trade order to form a matched electronic trade order. The second electronic trade order is originated by a second trader of the pre-selected group of traders.

In one aspect of the embodiment, the second electronic trade order comprises an IOM-generated quote message associated with an internal quote generated based on parameters and associated values selected by a second trader of the pre-selected group of traders.

In another embodiment, the system includes an internal provider server where the internal provider server includes an internal order matcher function. The system also includes a gateway communicatively coupled to the internal provider server and an external host system. The gateway is configured to provide a translation interface between the internal provider server and an external host system. The internal provider server is configured to match the electronic trade order to another electronic trade order to form a matched electronic trade order.

In yet another embodiment, in an internal provider server including an internal order matcher (IOM) function, provided is a method for internally matching at least a first electronic trade order. The internal provider server is communicatively coupled to a gateway, where the gateway configured to provide a translation interface between the internal provider server and an external host system. The method includes receiving a first order message representing the first electronic trade order. The first electronic trade order is originated via a trader of a pre-selected group of traders. The method also includes providing a first internal identifier in an internal identifier field of the first order message, and enabling a first indication in the first internally identified first order message to form a first IOM-controlled order message. The first indication indicates that the first electronic trade order is eligible for internal matching. The method further includes comparing the first IOM-controlled order message to a number of entries of an internal order book of the internal provider server, where each of the number of entries corresponds to a pending electronic trade order. If the first IOM-controlled order message can be matched to one of the entries, internally match the first electronic trade order to a pending electronic trade order represented by the one of the entries.

The entries of the internal order book may include one or more copies of external order messages associated with electronic trade orders not originated by the pre-selected group of traders, one or more copies of order messages associated with electronic trade orders originated by traders of the pre-selected group of traders, one or more order messages associated with electronic trade orders originated by traders of the pre-selected group of traders, and one or more IOM-generated quote messages associated with an internal quote generated the internal provider server based on parameters and associated values selected by a market maker of the pre-selected group of traders.

In an internal provider server including an internal order matcher (IOM) function, provided is another method for internally matching at least a first electronic trade order. The internal provider server is communicatively coupled to a gateway, where the gateway configured to provide a translation interface between the internal provider server and an external host system. The method includes receiving a first order message representing the first electronic trade order, where the first electronic trade order placed by a trader of a pre-selected group of traders. The method also includes providing a first internal identifier in an internal identifier field of the first order message, and enabling a first indication in the first internally identified first order message to form a first IOM-controlled order message. The first indication indicates that the first electronic trade order is eligible for internal matching. The method further includes comparing the first IOM-controlled order message to an IOM-generated quote message associated with an internal quote. The internal quote is generated by the internal provider server based on parameters and associated values selected by another trader of the pre-selected group of traders. If the first IOM-controlled order message can be matched to the IOM-generated quote message, the method additionally includes internally matching the first electronic trade order to the internal quote. In that case, the method includes adjusting at least one field of the IOM-generated quote message to reflect the internal match.

It should be understood that the present invention includes a number of different aspects and/or features which may have utility alone or in combination with other aspects or features. Accordingly, this summary is not an exhaustive identification of each such aspect or feature that is now or may hereafter be claimed, but represents an overview of certain aspects of the present invention to assist in understanding the more detailed description that follows. The scope of the invention is not limited to the specific embodiments described below, but is set forth in the claims now or hereafter filed.

### BRIEF DESCRIPTION OF THE DRAWINGS

FIG. 1 is a diagram of an exemplary electronic trading network including an external host system and a trading firm system having client terminals.

FIG. 2 is a detailed diagram of the trading firm system of FIG. 1, according to an embodiment of the invention.

FIG. 3 is an exemplary order message format that may be used to represent a trade order for matching by the electronic trading network of FIGS. 1 and 2, according to an embodiment of the invention.

FIG. 4 is an exemplary order message formed in response to a first trade order, according to an embodiment of the invention.

FIG. 5 is an exemplary order message resulting from the order message of FIG. 4 upon identifying that the trade order originated from a trader of the pre-selected group of traders.

FIG. 6a is a copy of the order message of FIG. 5 including a time-stamp.

FIG. 6b is a copy of the order message of FIG. 6a additionally including a linked identification to an order message of FIG. 7b.

FIG. 7a is an exemplary order message resulting from the order message of FIG. 5 upon a determination that no internal match can be made for the trade order.

FIG. 7b is the exemplary order message of FIG. 7a additionally including an internal identification that provides the linked identification to the order message of FIG. 6b.

FIG. 8 is an exemplary order message resulting from the order message of FIG. 7b updated upon an occurrence of a full match of the trade order at the external host system.

FIG. 9 is an exemplary order message resulting from the order message of FIG. 7b updated upon an occurrence of no match of the trade order at the external host system.

FIG. 10 is an exemplary order message resulting from the order message of FIG. 7b updated upon an occurrence of a partial match of the trade order at the external host system.

FIG. 11 is a copy of the order message of FIG. 6b that has been updated to reflect a full match of the first trade order at the external host system.

FIG. 12 is a copy of the order message of FIG. 6b that has been updated to reflect no match of the first trade order at the external host system.

FIG. 13 is a copy of the order message of FIG. 6b that has been updated to reflect a partial match of the first trade order at the external host system.

FIG. 14 is an exemplary order message resulting from a second trade order upon identifying that the second trade order originated from a trader of the pre-selected group of traders.

FIG. 15 is an exemplary order message to delete the order message of FIG. 7b at the external host system.

FIG. 16 is an exemplary order message resulting from deletion of the order message of FIG. 7b at the external host system.

FIG. 17 is an exemplary order message resulting from internally matching the (buy) order message of FIG. 6b with the order message of FIG. 14.

FIG. 18 is an exemplary order message resulting from internally matching the (sell) order message of FIG. 14 with the order message of FIG. 6b.

FIG. 19 is an exemplary IOM-generated quote message, according to an embodiment of the invention.

FIG. 20 is an exemplary order message resulting from a third trade order.

FIG. 21 is the exemplary IOM-generated quote message of FIG. 19, updated to reflect an internal match with the order message of FIG. 20.

FIG. 22 is an exemplary order message resulting from a fifth trade order.

FIG. 23 is the exemplary IOM-generated quote message of FIG. 21, updated to reflect an internal match with the order message of FIG. 22.

FIG. 24 is an exemplary order message resulting from a sixth trade order.

FIG. 25 is the exemplary IOM-generated quote message of FIG. 23, updated to reflect an internal match with the order message of FIG. 24.

FIG. 26 is the exemplary IOM-generated quote message of FIG. 25, updated to reflect a change in the best ask price.

FIG. 27 is an exemplary order message resulting from a fourth trade order.

FIG. 28 is another exemplary IOM-generated quote message, according to an embodiment of the invention.

### DETAILED DESCRIPTION OF THE PREFERRED EMBODIMENTS

Cash and derivatives markets are continuously updating as many traders are placing trade orders, changing trade orders and canceling trade orders simultaneously. Accordingly, trade orders must be matched as quickly as possible. Further, a proportional relationship exists between the number of pending, or unmatched, trade orders residing at an external host system and the time it takes for one trade order to be matched to another trade order or quote. In general, the larger the number of pending trade orders for a particular tradable instrument residing at an external host system, the more likely the trade order will be quickly matched.

While a quick trade order match is of paramount importance to the trader, so too are the profits accrued at the end of a day. As a result, traders desire to minimize the fees they pay to the external host system(s) performing their trade order matching. In the past, alternative matching engines, or so called alternative trading systems (ATSs) have been implemented which do not require a trade order to be matched with another trade order or a quote at a traditional external host system or exchange. As a result, the traders using the matching engine provided by an ATS may be able to lower, or in some cases avoid, paying trading and clearing fees. Because a full-scale ATS is quite expensive however, it is typically implemented only by large organizations placing a large number of trade orders.

As described with reference to the accompanying figures, the present invention provides a system and method for internally matching electronic trade orders originated by a pre-selected group of traders, while obtaining the best possible price for each trade order and while minimizing the trading and clearing fees associated with trade order matching by an external host system. This is accomplished without compromising the speed with which the trade orders are matched. Although the present invention is preferably implemented on an “internal” provider server (i.e., a server or equivalent not hosted or operated as part of, and/or controlled by an external host system), it is contemplated that the present invention may also be implemented on one of any number of different types of internally controlled microprocessor-based or computing device communicatively coupling an external host system(s) to a client terminal(s) for purposes of facilitating electronic trading.

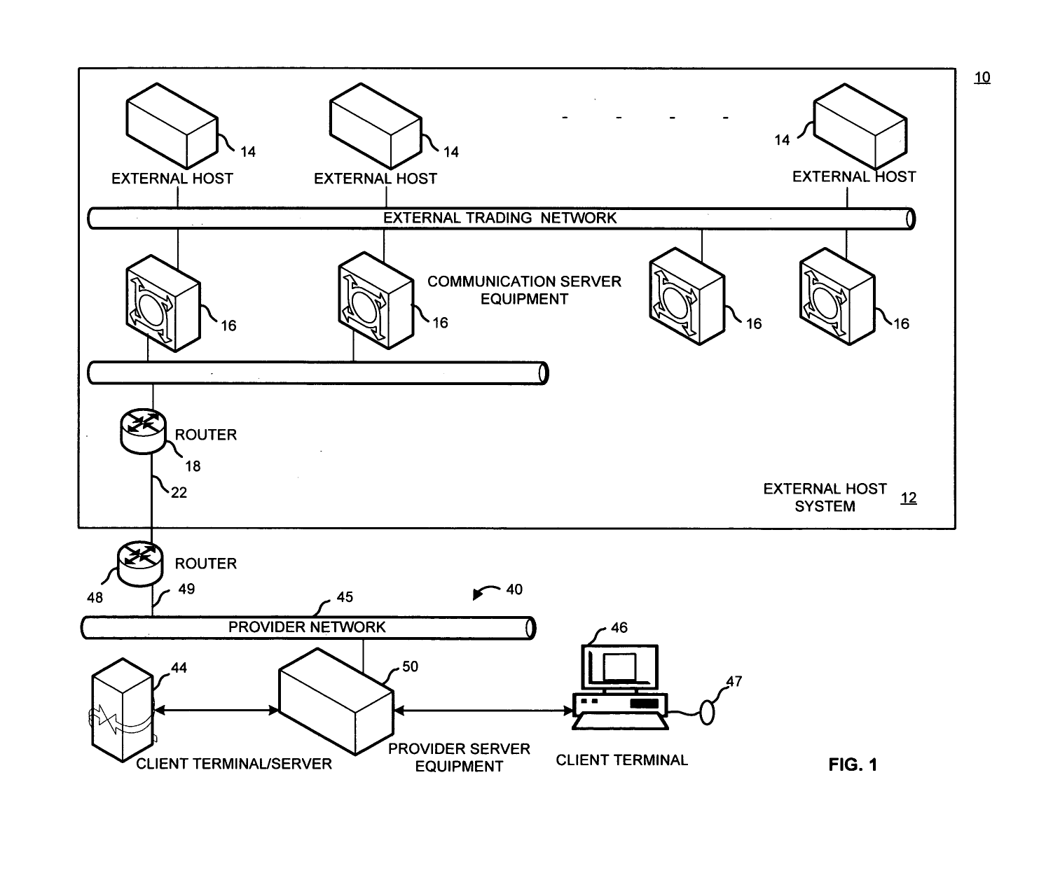

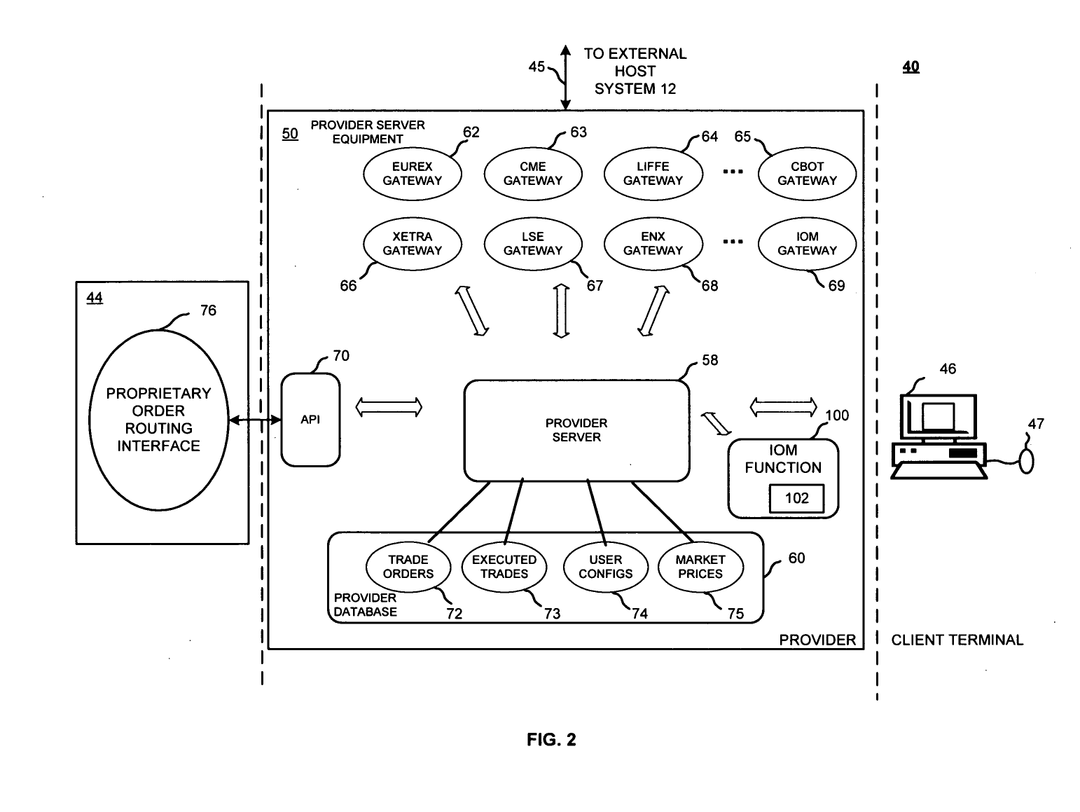

FIG. 1 is a diagram of an exemplary electronic trading network 10 including an external host system 12 (e.g., a trading exchange) and an internal trading firm system 40 communicatively coupled to a number of client terminals illustrated as a first client terminal 44 and a second client terminal 46. In the illustrated example, the first client terminal 44 is shown as a server that includes a proprietary interface to the provider server equipment 50 (see, FIG. 2), while the second client terminal 46 is shown as a personal computer capable of interfacing with the provider server equipment 50 via one of any number of suitable methods.

The external host system 12 is coupled to the internal trading firm system 40 via at least one host network router 18 and at least one trading firm network router 48 and at least one communication link 22 therebetween. The communication link 22 may be one of any number of suitable communications links such as, for example, a LAN, a WAN, the Internet, etc., to allow communication between the first and second client terminals 44, 46 and the trading exchange hosts 14. Although only one external host system 12 and one internal trading firm system 40 are illustrated in FIG. 1, it should be understood that additional external host systems 12 and/or additional internal trading firm systems 40 may be included in the electronic trading network 10.

Referring to FIG. 1, the external host system 12 includes a number of external hosts 14 configured to, among other things, enable external matching, execution and clearing of trade orders, maintain external trade order books, positions and price information, manage and update trading exchange(s) databases and provide external host system data such as market data, market prices and externally executed trade order information to the first and second client terminals 44, 46 via the provider server equipment 50. For ease of discussion, an executed trade order may be defined as a matched/filled trade order, either partially or fully, where copies of the matched trade order have been forwarded to associated parties (e.g., the trading firm, the trader, the clearing entity). Similarly, a cleared trade order may be defined as an executed trade order that has been cleared and settled where typically a third party (e.g., the Options Clearing Company) acts as a guarantor to ensure fulfillment of the obligations of the executed trade order.

The external host system 12 also includes communication server equipment 16 configured to distribute external host system data (e.g., market data), to the trading firm system 40 and to forward incoming trade orders to the external host(s) 14. Host network routers 18 are further included to route incoming and outgoing data to and from the external host system 12.

Although shown as including three external hosts 14, four communication servers 16, and one router 18, it is contemplated that the external host system 12 may include any number of external hosts, communication servers and routers in one of any number of suitable configurations to enable electronic trading. Further, although not separately illustrated, is also contemplated that the external host system may include, or be coupled to, one or more ATSs.

The trading firm system 40 includes provider server equipment 50 operatively coupled to the external host system 12 via a provider network 45 and one or more trading firm routers 48. The first and second client terminals 44, 46 are operatively coupled to the provider server equipment 50 using well known means (e.g., a LAN, a WAN, a wireless network, the Internet). Although only the two client terminals 44, 46 are illustrated, it should be understood that more or less client terminals may be included in the trading firm system 40.

Each of the first and second client terminals 44, 46 is configured to enable electronic trading by one or more traders. For example, the first client terminal 44 may be associated with an on-line broker (e.g., Charles Schwab, ETrade, TD Waterhouse) and therefore be one of a number of personal computers that enable traders to place trade orders from the comfort of their home or office. The second client terminal 46 may be associated with a trading firm and may therefore be located in a trading firm's office, a third party location or a trading exchange building to enable the trader to place trade orders.

In the illustrated example, the second client terminal 46 includes a user input device 47. Although preferably a computer mouse having right button to enable a right click, a left button to enable a left click and a center scroll wheel to enable one dimensional scrolling, the user input device 47 may be one of any number of suitable input devices capable of manipulation by a trader for the purpose of placing trade orders (e.g., a keyboard/key pad, a biometric input device) via an interactive trading screen, or for purposes of initiating and controlling algorithmic-based automated trading.

In the illustrated example, the provider server equipment 50 and its associated software may be provided by one of any number of entities. For example, the provider server equipment 50 and associated software may be provided by an ISV, an on-line broker, an investment bank, a clearing house or any suitable corporation associated with electronic trading. As discussed below, the provider server equipment 50 of FIG. 1 includes a provider server(s), a database(s), an internal order matcher (IOM) and, in some cases, one or more application program interfaces (APIs) and/or one or more exchange gateways.

More specifically, FIG. 2 is a more detailed diagram of the trading firm system 40, according to an embodiment of the invention. The trading firm system 40, including the provider server equipment 50, is configured to enable a pre-selected trader(s) to place one or more trade orders that may be internally matched within the provider server equipment 50 to other trade orders or quotes placed by other pre-selected traders, or may be “externally” matched within the external host system 12. Trade orders that are not initially internally matched are forwarded from the provider server equipment 50 to the external host system 12 for either external matching or, in some cases, subsequent internal matching, according to an embodiment of the invention. As a result, trading fees and clearing fees paid to the external host system(s) 12 may be minimized without compromising the speed with which trade orders are executed and without compromising the guarantee of the best trade order price.

As illustrated in FIG. 2, the provider server equipment 50 includes a provider server 58, a provider database 60 and a number of (e.g., exchange) interfaces or gateways 62-69. Each of the gateways 62-69 is an individual, customized network point that serves as an interface between the provider server equipment 50 and the external host system 12.

Among other things, the provider server 58 is configured to route external host system data to the first and second client terminals 44, 46, to assign internal identifiers to incoming trade orders and, in some cases, to route them to the external host system 12 for possible execution. The provider server 58 also provides market data to the traders, provides “copies” of executed trade orders and associated order messages to appropriate databases and clearing entities, and provides trade order status updates and executed trade order confirmations to the first and second client terminals 44, 46.

While not required, the pre-selected group of traders preferably includes at least one market maker, or specialist, to enable generation of “internal” quotes for purposes of increased internal market liquidity (the ability to buy or sell a tradable instrument without causing a significant movement in the price of the tradable instrument; ready and willing buyers and sellers). The pre-selected group of traders may include one of a number of group types. For example, the pre-selected group of traders may be selected customers of a financial institution (e.g., TD Waterhouse).

As will be described below, trade orders, internal quotes and their status updates are formatted as order messages having a number of fields, the contents of which are modified as the order messages are routed between and among the devices of the external host system 12 and the provider server equipment 50. As used herein, the term “internal quote” includes a pair of trade orders generated and maintained by an internal order matcher (IOM) function 100 of the provider server equipment 50. One trade order, or side, of the internal quote is an order to buy a tradable instrument while the other trade order, or other side, of the internal quote is an order to sell a tradable instrument. For ease of describing the various embodiments of the invention, the internal quote is preferably formatted as two order messages, however other formats are contemplated.

As will also be described below, the IOM function of FIG. 2 operates in conjunction with the provider server 58. Further, although illustrated as a separate function in communication with the provider server 58, the IOM function 100 may alternatively reside within the provider server 58 or in another element of the provider server equipment 50.

In general, after initialization, the IOM function 100 enables pending order messages originated by a pre-selected group of traders, to first be listed in its internal trade order book 102 for internal matching with internal quotes (or with other trade orders originated by the pre-selected group of traders), rather than be routed to the external host system 12 for external matching. Pending trade orders that are unable to be internally matched by the IOM function 100 are subsequently routed (as associated pending order messages) to the external host system 12 for listing in its external order book.

The external trade order book may be defined as a trade order list that is maintained by the external host system 12. The external trade order book includes order messages that are associated with pending trade orders that may or may not have been originated by the pre-selected group of traders. That is, the external trade order book may include order messages associated with pending trade orders, originated the pre-selected group of traders, that were previously routed to and unable to be internally matched by the IOM function 100. The external trade order book may also include order messages associated with pending trade orders that were not originated by one of the pre-selected group of traders, and instead were originated via the external host system 12.

In an embodiment, the internal trade order book 102 may be defined as an internal trade order list that is maintained by the IOM function 100. The internal trade order book 102 includes order messages and copies of order messages. Each of the order messages is associated with a pending trade order originated by one of the pre-selected group of traders. Each of the copies of order message may or may not be associated with a pending trade order originated by one of the pre-selected group of traders. That is, a copy of an order message may be associated with a pending trade order originated by one of the pre-selected group of traders. Such a copy is hereinafter referred to as a copy of an IOM-controlled order message. A copy of an order message may also be associated with a pending trade order that was not originated by one of the pre-selected group of traders (a copy of an external order message). Rather, the pending trade order was originated via the external host system 12. A counterpart order message (i.e., an external order message) is listed in the external trade order book for each of the copies of external order messages listed in the internal trade order book 102. (see, Table 1).

TABLE 1

| External Order Book | Internal Order Book |
|---|---|
| (Host System 12) | (IOM function 100) |
| External order messages associated | Copies of external order messages |
| with pending trade orders not | associated with pending trade orders |
| originated by the pre-selected | not originated by the pre-selected |
| group of traders | group of traders |
| Order messages associated with | Copies of order messages associated |
| pending trade orders originated by | with pending trade orders originated |
| the pre-selected group of traders | by the pre-selected group of traders |
| and unmatched by the IOM | |
| function 100 | |
| | Order messages associated with |
| | pending trade orders originated by the |
| | pre-selected group of traders |

Although order messages listed in the external trade order book, and order messages and copies of order messages listed in the internal trade order book 102 reflect pending trade orders that are organized using a price/time priority arrangement in the exemplary embodiments (i.e., in a list reflecting the best price first and then received time sequence of entry), it is contemplated that they may also be organized using an aggregated arrangement, a non-aggregated arrangement, a pro-rata arrangement or any other suitable arrangement.

Unlike the prior art systems such as an ATS, the IOM function 100 maintains the internal trade order book 102 which includes order messages and copies of order messages associated with trade orders originated by the pre-selected group of traders, and includes copies of order messages associated with pending trade orders that were not originated by the pre-selected group of traders. Order messages linked to copies of order messages in the internal trade order book 102 are listed in the external trade order book. Further, based on its internal trade order book 12, the IOM function 100 internally matches only those trade orders, including quotes, originated by the pre-selected group of traders; it does not however execute and clear the internally matched trade orders. Additionally, the IOM function 100 does not match, execute or clear trade orders that were not originated by the pre-selected group of traders.

Referring again to FIG. 2, the provider server equipment 50 further includes a number of databases 60 configured to maintain data associated with trade orders 72, executed trade orders 73, user configurations 74 and market prices 75, to name a few. In the illustrated example, an application programming interface API(s) 70 is included to enable data flow between a proprietary order routing interface 76 of the first client terminal 44 and the provider server 58.

Each of the gateways 62-69 to the various exchanges, etc. may include internal provider software and/or externally provided software to enable the provider server 58 to communicate with the individual external host system(s) 12. The gateways 62-69 are configured to translate the different external data structures and message types into internal data structures and message types suitable for use by the provider server 58 and the IOM function 100, and vice versa. Although shown as resident in the provider server equipment 50, it is contemplated that one or more of the gateways 62-69 may be resident in the external host system 12. In addition, the individual databases illustrated in the database 60 may be included in one or more servers. Other suitable configurations of the trading firm system 40 are possible.

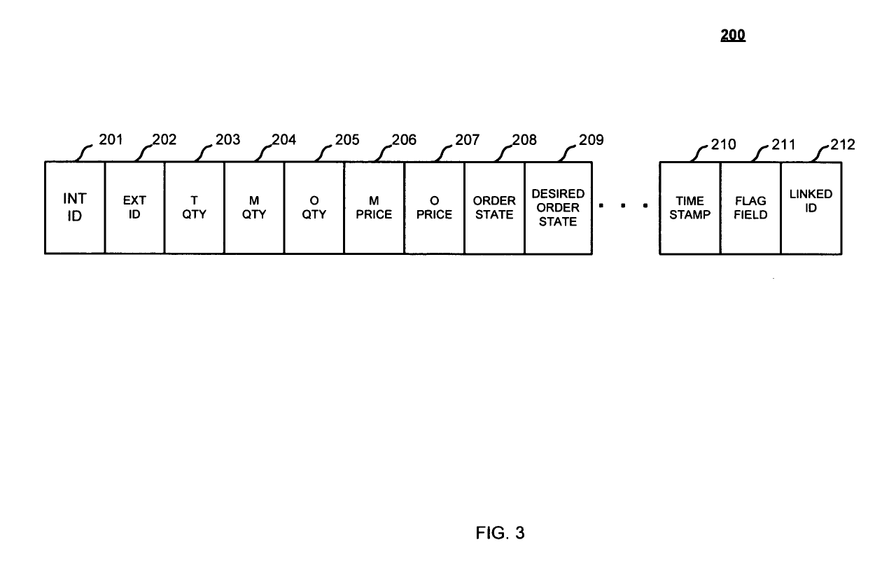

FIG. 3 is an exemplary order message format 200 of an order message that may be used to represent a trade order (or one side of an internal quote) before, during and after matching and execution by the electronic trading network of FIGS. 1 and 2, according to an embodiment of the invention. In general, contents of the information fields of the order message format 200 designate identification, time, trade order quantity, status of the trade order, price for the trade order, etc. While the message format of FIG. 3 includes specific information fields in a specified order shown, it should be understood that any number of suitable message formats may be utilized to represent a trade order.

More specifically, the order message format 200 includes a number of pre-assigned information fields 201 through 212 that are utilized and/or updated at different times during a trade order execution cycle. Each of the information fields 201-212 includes a number of alpha-numerical characters representing (bytes of) data associated with a trade order. In the illustrated example, the pre-assigned information fields of the order message format 200 include an internal identifier field 201 to indicate an identification number assigned by the provider server 58; an external identifier field 202 to indicate an identification number assigned by the external host system 12; a total quantity field 203 to indicate a total (buy/sell) order quantity, a matched order quantity field 204 to indicate a matched trade order quantity; and an open trade order quantity field 205 to indicate an open trade order quantity (not yet matched), an averaged matched price field 206 to indicate an average price for the matched trade order quantity (or portion thereof). The pre-assigned fields of the order message 200 also include a trade order limit price field 207 to indicate a maximum (buy) or a minimum (sell) price limit for the trade order; an order state field 208 to indicate the current state of the trade order; a desired order state field 209 to indicate the traders desired trade order state; and a time stamp field 210 to indicate the most recent update of one of the pre-assigned fields 201-212 by, for example, the external host 14 or the IOM function 100.

The order state field 208 is set in response to trade order updates that may be received from the external host system 12 or from one or more of the client terminals. The order state field 208 may reflect one of an active state, an inactive state, a completed state, an unknown state, a hold state, a none state, a cancelled state (an order deletion by either the external host system 12 or the provider server 58 due to incorrectly filled fields) and a stop state. As described in detail below, a stop state is used to disable a buy side and/or a sell side of an internal quote when a security parameter limit is reached. The order state field 208 may be set by the IOM function 100 for IOM-controlled order messages. For example, the IOM function 100 will set the order state field 208 of an IOM-generated quote message to the stop state when a security parameter limit is reached. The order state field 208 may also be set by one of the gateways 62-69 in copies of pending order messages (i.e., status updates) routed from the external host system 12 to the provider server 58, where the copies are derived from IOM-generated order messages. The order state field 208 additionally may be set to the hold state or the cancelled state by the provider server 58 in order messages representing trade orders from the client terminals.

The desired order state field 209 is set according to the trade order updates that may be provided by the external host system 12 or by one or more of the client terminals. The desired order state field 209 may reflect one of an active state, an inactive state, a completed state, and a none field. The desired order state field 209 is set in an order message representing a trade order from one of the client terminals. In the case of an IOM-generated order message however (discussed below), the IOM function 100 sets the desired order state field 209.

Also included in the order message format 200 are a flag field 211, a linked ID field 212 and an error code field (not separately illustrated). The error code field provides a numerical indication of an error in a trade order. The error indicated may be, for example, that a trade order is not in its latest known state or that a trade order match was attempted with a quote having a stopped state in its order state field 208. The flag field 211 includes a number of settable bits where each of the settable bits represents a flag. For example, when set, the right-most bit indicates that the order message is an IOM-controlled order message, and when set, the next bit to the left of the right-most bit indicates that the order message is an IOM-generated order message. The IOM-controlled order message is formed by the provider server 58 to indicate that a particular trade order was originated by one of the pre-selected group of traders, and is listed in the internal trade order book 102. In an embodiment, the IOM-generated order message is formed by the IOM function 100 as a counterpart to an IOM-controlled order message as a result of an inability to internally match the trade order associated with the IOM-controlled order message. The IOM-generated order message is not listed in the internal trade order book 102; rather it is linked via its linked ID field 212 to its counterpart IOM-controlled order message.

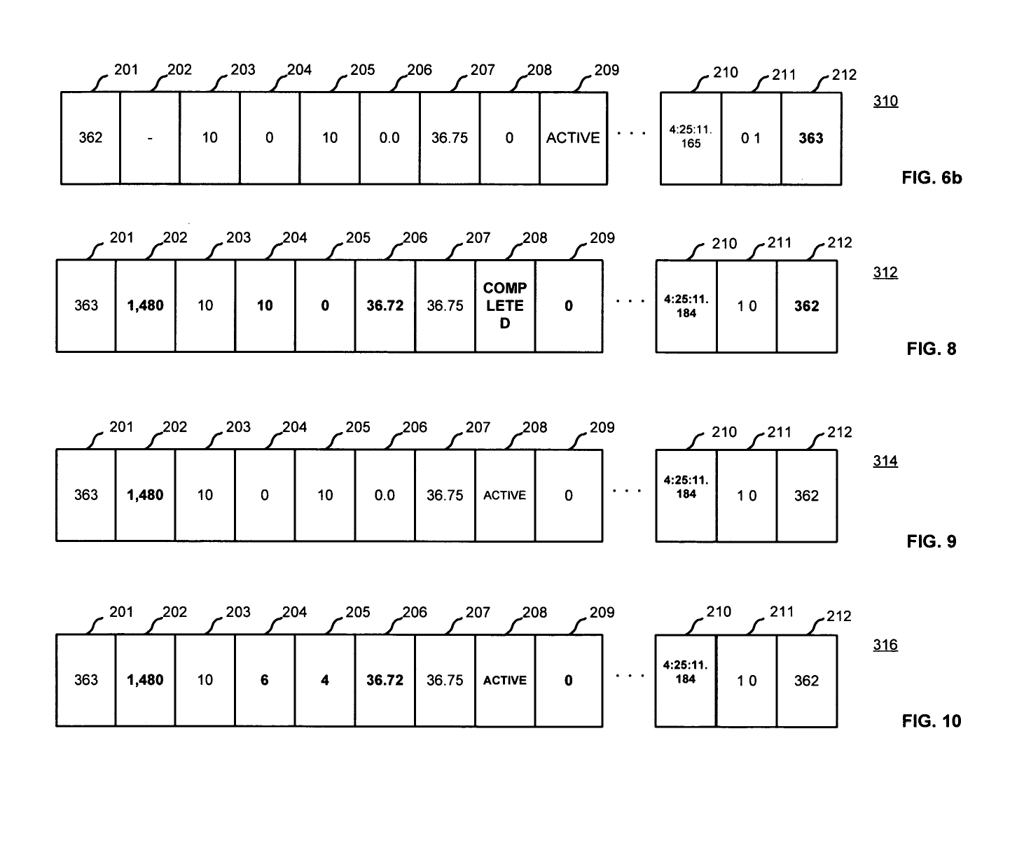

As discussed below in connection with FIG. 6 and FIGS. 12-14, the linked ID field 212 is utilized when an IOM-controlled order message is fully or partially unmatched by the IOM function 100 and has a counterpart IOM-generated order message at the external host system 12. In that case, the internal identifier of the IOM-controlled order message is inserted in the linked ID field 212 of its counterpart IOM-generated order message upon counterpart generation by the IOM function 100. Conversely, the internal identifier of the counterpart IOM-generated order message is subsequently inserted in the linked ID field 212 of the IOM-controlled order message upon receipt of a status (e.g., fully matched, partially matched, unmatched) of the counterpart IOM-generated order message from the external host system 12.

As discussed above, the pre-selected group of traders preferably includes at least one market maker, or equivalent, to enable generation of one or more internal quotes by the IOM function 100. In the illustrated example, such internal quotes are represented as a two order messages, combined to form an IOM-generated quote message having a buy side and a sell side. The IOM-generated quote message is utilized by the IOM function 100 to facilitate increased internal matching of trade orders originated by the pre-selected group of traders.

While such IOM-generated quote messages may be generated by the IOM function 100 in one of any number of suitable ways, the IOM function 100 preferably generates IOM-generated quote messages based on predefined parameters and selected values for those predefined parameters entered via the first and/or second terminal 44, 46 and/or the API 70. A user-input screen displayed on the first and/or second terminal 44, 46 may be provided to assist the market maker in choosing his/her preferred predefined parameters and then selecting values for those predefined parameters. In one example, the predefined parameters include a number of price parameters to define prices on both the buy and sell side of the quote, a number of quantity parameters to define quantity on both the buy and sell side of the quote, and a number of security parameters to define associated security functions that limit risk factors, it is contemplated that additional predefined parameters may be used to enable internal quote generation by the IOM function 100.

In the example, the market maker, or equivalent, chooses at least one price parameter from among a number of price parameters. Accordingly, the market maker may choose from among a tick value price parameter, an absolute value price parameter, a percent value price parameter, and an average value price parameter. The price parameter establishes a scheme that will be used by the IOM function 100 to set the buy side price and the sell side price of the internal quote. After choosing the price parameter(s), the market maker selects a numerical value for the chosen price parameter(s). Subsequently, the IOM function 100 applies the numerical value(s) of the chosen price parameter(s) to a market price (e.g., a last traded price, a best bid price or the price associated with the best bid, a best ask price or the price associated with the best ask, a settlement price, or any other designated price) of the tradable instrument by the IOM function 100 to formulate the buy side price and the sell side price of the internal quote, represented by an associated IOM-generated quote message (i.e., internal quote).

The selected numerical value for the tick value price parameter may be a tick value, where the term ‘tick value’ refers to a minimum price fluctuation (a.k.a., a trade increment) of a tradable instrument. For example, the numerical value may be 2 ticks on a tradable instrument where each tick equals 1¢. In that case, 2 ticks or 2¢ is subtracted from the best bid price to determine a buy side price of the quote, and two ticks or 2¢ is added to the best ask price to determine the sell side price of the quote. The selected numerical value may also be an absolute value for the absolute value price parameter, where the absolute value is referenced to a multiple of a minimum price increment for the tradable instrument. For example, the numerical value may be 20¢ where a minimum price increment is 10¢. In that case, 20¢ is subtracted from the best bid price to determine a buy side price of the quote, and 20¢ is added to the best ask price to determine the sell side price of the quote. The selected numerical value may further be a percentage value for the percentage value price parameter, where the percent value is referenced to a percentage of the market price for the tradable instrument at a particular moment in time. For example, if the numerical value is selected to be 0.1%, and the best bid price for the tradable instrument at a particular moment in time is $100.00 per unit (e.g., $100 per share of stock), and the best ask price for the tradable instrument at the particular moment in time is $100.20, 10¢ is subtracted from the $100 to determine a buy side price of the quote, and 10.02 ¢ is added to $100.20 to determine the sell side price of the quote.

The selected numerical value may additionally be an average value for the average value price parameter, where the average value is referenced to an average of one or more of the best bid prices to determine the buy side price of the quote and an average of one or more of the best ask prices to determine the sell side price of the internal quote. There are two primary ways in which the average value may be calculated. First, the average price value may be calculated based on a fixed quantity of the tradable instrument. For example, an average value used to determine a buy side price of the internal quote may be calculated based on an average of a fixed quantity (e.g., 40) of the best bid prices of the tradable instrument, and an average value used to determine a sell side price of the internal quote may be calculated based on an average of a fixed quantity of the best ask prices of the tradable instrument. Accordingly, using the example of a fixed quantity of 40, if a quantity of 30 of the tradable instrument has a best bid price of $60.00, and if a quantity of 4 of the tradable instrument has a second best bid price of $59.90, and if a quantity of 6 of the tradable instrument has a third best bid price of $59.80, then an average value equal to $59.96 would be used to determine a buy side price of the internal quote.

Second, the average value may be calculated based on an integer market depth of the tradable instrument. For example, an average value used to determine a buy side price of the internal quote may be calculated based on an averaged price of the tradable instrument associated with the first two best bid prices at a particular moment in time, and an average value used to determine a sell side price of the internal quote may be calculated based on an averaged price of the tradable instrument associated with the first two best ask prices at the particular moment in time. Accordingly, using the example of a market depth of two, if a quantity of 30 of the tradable instrument has a best bid price of $40.00, and a quantity of 20 of the tradable instrument has a second best bid price of $40.05, then an average value price used to determine a buy side price of the internal quote would be $40.02

As noted above, the predefined parameters required for generation of the internal quote, represented by an associated IOM-generated quote message, include a quantity parameter(s) to define the buy side quantity and the sell side quantity of the internal quote. Like the price parameters discussed above, the market maker or equivalent, selects at least one quantity parameter from among a number of quantity parameters. The quantity parameter establishes a scheme that will be used by the IOM function 100 to set the buy side quantity and the sell side quantity of the internal quote. In an embodiment, the market maker may choose from among a fixed quantity parameter, a best quantity parameter, and an accumulated quantity parameter. The market maker may augment his/her quantity parameter with an optional refill quantity parameter.

After choosing the quantity parameter(s), the market maker defines, either numerically or otherwise, a quantity value for the chosen quantity parameter(s). Subsequently, the IOM function 100 applies the quantity value(s) of the chosen quantity parameter(s) to form the buy side quantity and the sell side quantity of the internal quote.

The quantity value may be a fixed quantity value, where the buy side quantity and the sell side quantity of an internal quote for the tradable instrument is a predetermined fixed number. For example, if a fixed quantity parameter is selected for the tradable instrument and the predetermined fixed number is 30, the buy side and the sell side of the internal quote generated by the IOM function 100 will each reflect a quantity of 30. In another example, if a fixed quantity parameter is selected for the tradable instrument and a first predetermined fixed number is 30 and a second predetermined fixed number is 50, the buy side of the internal quote generated by the IOM function 100 will reflect a quantity of 30 while the sell side of the quote will reflect a quantity of 50. Many other examples are contemplated. During operation of the IOM function 100, as one of the buy side and/or sell side of the internal quote is fully or partially matched, when chosen in conjunction with the fixed quantity value, a refill quantity parameter can be configured to refill the buy side and/or the sell side of the internal quote.

The quantity value may also be a best quantity value, where at a selected moment in time, the buy side quantity of an internal quote equals an integer multiple of the quantity associated with the best bid price for a tradable instrument and the sell side quantity of the internal quote equals the quantity associated with the best ask price for the tradable instrument. If chosen, the best quantity value may further include minimum and/or maximum quantity values in order to limit risk taken by the market maker. For example, if the best quantity value is chosen with a minimum quantity value of 100, a maximum quantity value of 500, and a multiplier of 2, during operation of the IOM function 100, a quantity of 10 of a tradable instrument with a best bid price of $16.10, and a quantity of 25 of the tradable instrument with a best ask price of $16.12, will yield an internal quote having a buy side quantity of 100 and a sell side quantity of 100. When chosen in conjunction with the best quantity value, the refill quantity parameter can be configured to refill the buy side and/or the sell side of the internal quote.

The quantity value may further be an accumulated quantity value, where at a selected moment in time, the buy side quantity of an internal quote is equal to a quantity reflected in an integer market depth of the tradable instrument that is associated with the best bid prices, and the sell side quantity of the internal quote equals a quantity reflected in an integer market depth of the tradable instrument that is associated with the best ask prices. If chosen, the accumulated quantity value may further include a multiplier and/or minimum and/or maximum quantity values in order to limit risk taken by the market maker. For example, if the accumulated quantity value is chosen with a two level market depth quantity for both the best bid and best offer prices, during operation of the IOM function 100, a quantity of 10 of a tradable instrument with a best bid price of $16.10, a quantity of 50 with a second best bid price of $16.09, and a quantity of 75 with a best ask price of $16.12, and a quantity of 40 with a second best ask price of 16.13 will yield an internal quote having a buy side quantity of 60 and a sell side quantity of 115. If a minimum quantity value of 100 and a maximum quantity value of 500 are also stipulated when choosing the accumulated quantity value, then using the two level market depth example, the internal quote generated by the IOM function 100 will have a buy side quantity of 100 and a sell side quantity of 115. Integer multipliers as discussed above may also be stipulated when choosing the accumulated quantity value. In addition, when chosen in conjunction with the accumulated quantity value, the refill quantity parameter can be configured to refill the buy side and/or the sell side of the quote.

The market maker or equivalent, has the option to enable none, one or more security parameters in order to limit risk factors associated with internal quote generation by the IOM function 100. The security parameters include a maximum traded quantity, a maximum position, a maximum long position, a maximum short position, a maximum long value, and a maximum short value.

If the maximum position is enabled, the market maker can stipulate a maximum and/or minimum sum quantity of his/her trade orders of a particular tradable instrument that were matched, beginning with his/her first trade order of the tradable instrument. The maximum position includes an aggregated sum of trade orders to both buy (indicated as a positive sum) the tradable instrument and sell (indicated as a negative sum) the tradable instrument. During operation of the IOM function 100, when the maximum position for the tradable instrument is reached for either the buy or sell side of the internal quote, then the order state 208 of the associated side of the internal quote changes from an ‘active’ state to a ‘stopped’ state. The stopped state prevents the associated side of the quote from being matched by the IOM function 100 to incoming trade orders from the pre-selected group of traders.

If the maximum long position is enabled, the market maker can stipulate a maximum positive sum quantity of his/her buy and sell trade orders of a particular tradable instrument that were matched, beginning with his/her first trade order of the tradable instrument. During operation of the IOM function 100, when the maximum long position for the tradable instrument is reached, then the order state 208 of the buy side of the internal quote changes from an active state to a stopped state.

If the maximum short position is enabled, the market maker can stipulate a maximum negative sum quantity of his/her sell and buy trade orders of a particular tradable instrument that were matched, beginning with his/her first trade order of the tradable instrument. During operation of the IOM function 100, when the maximum short position for the tradable instrument is reached, then the order state 208 of the sell side of the internal quote changes from an active state to a stopped state.

If the maximum long value is enabled, the market maker can stipulate a maximum sum dollar value of his/her buy and sell trade orders (indicated as a positive sum) of a particular tradable instrument that were matched, beginning with his/her first trade order of the tradable instrument. During operation of the IOM function 100, when the maximum long value for the tradable instrument is reached, then an order state 208 of the buy side of the internal quote changes from an active state to a stopped state.

If the maximum short value is enabled, the market maker can stipulate a maximum sum dollar value of his/her sell and buy trade orders (indicated as a negative sum) of a particular tradable instrument that were matched, beginning with his/her first trade order of the tradable instrument. During operation of the IOM function 100, when the maximum short value for the tradable instrument is reached, then an order state 208 of the buy side of the internal quote changes from an active state to a stopped state.

In cases where predefined parameters and their associated values are received by the IOM functionality 100 via the provider sever 58, an internal quote, or IOM-generated quote message, is created upon initialization of the IOM function 100. The internal quote is never forwarded to the external host system 12. Rather, it remains in the IOM function 100 to provide liquidity for internal trade order matching. The IOM-generate quote message includes a buy side order message format and a sell side order message format. Each of the buy side and sell side order message formats may be formatted as described in connection with FIG. 3. It is contemplated however, that any number of suitable message formats may be utilized to represent the internal quote.

Referring again to FIG. 3, as used herein, the term “active” in either the order state field 208 or the desired order state field 209 refers to a trade order that is available for matching by either the IOM function 100 or the external host system 12. For example, the IOM function 100 sets an active state in an IOM-controlled order message when the IOM function 100 routes an associated, or linked IOM-generated order message to the provider server 58 for routing to the external host system 12, and the external host system 12 sets an active state in the linked IOM-generated order message upon receipt of the linked IOM-generated order message.

As used herein, the term “completed” refers to a trade order that is fully matched, or to a deleted trade order that has been deleted by the trader prior to being fully matched or after being partially matched. The term “none” refers to a trade order that does not have a value, the term “inactive” refers to a trade order that has been pulled from the external host system 12 by the trader but a copy of the trade order remains resident in the provider server 58. The term “unknown” refers to an unknown state for a trade order due to, for example, a network problem or communication link outage. The term “cancelled” refers to a trade order that has been cancelled by the external host system 12 or the IOM function 100 because, for example, violation of exchange rules or system problems. The term “hold” refers to a trade order that is not processed by the provider server 58 because of, for example, the absence of an exchange trade identification number which identifies the trader at the external host system 12, or insufficient permissions or exceeded trading limits.

Referring again to FIG. 1, using prior art methods (without the IOM function 100), after origination by a trader via the client terminal 44 or 46, a trade order is forwarded to the provider server equipment 50 as an order message. The order message is configured in a suitable message format. In the case of the order message format 200 described above, the information is included in the total quantity field 203, the open quantity field 205, the trade order limit price field 207 and the desired order state 209. Upon receipt by the provider server 58, the trade order is assigned an internal identifier via the internal identifier field 201, thereby identifying the trade order as a pending trade order. A copy of the pending trade order with its internal identifier is stored in a suitable memory location (e.g., a RAM location of the provider server equipment 50). A copy of the pending trade order is also sent to the originating client terminal 44 or 46, and stored in a suitable database. The original pending trade order is routed to the external host system 12 where, upon receipt, it is time-stamped and assigned an external identifier via the time stamp field 210 and the identifier field 202, respectively. The external host system 12 then attempts to match the pending trade order. The pending trade order may remain unfilled or may be partially or fully filled (matched). Upon determining whether the pending trade order is unfilled, partially filled or fully filled, a status of the pending/executed trade order is routed by the external host system 12 to the provider server equipment 50. The status of the pending/executed trade order is reflected in status fields of the order message (e.g., modification of the order state field 208 and the desired order state field 209). Additional status' regarding the pending trade order may be routed to the provider server equipment 50, including a last status routed to the provider server equipment 50 when the pending trade order is fully executed.

### Operation of the IOM Function 100

In general, the IOM function 100 is configured to determine whether a pending trade order, originated by a trader of the pre-selected group of traders, can be matched with an internal quote originated or in another embodiment, with another pending trade electronic order and/or an internal quote originated by another trader of the pre-selected group of traders, according to an embodiment of the invention. If it is determined that the pending trade order, originated by a trader of a group of pre-selected traders, can be matched with an internal quote or with another pending trade order originated by a trader of the pre-selected group of traders, the pending trade order is matched by the IOM function 100. The associated IOM-generated quote messages or order messages are updated accordingly. If not, an order message associated with the unmatched pending trade order is routed to the external host system 12 for matching.

After initialization of the IOM function 100, a ‘copy’ of a pending order message is used to represent an associated pending trade order, and is temporarily retained in a memory location or a storage medium of at least one of the provider server 58, the IOM function 100, the trade order database 72, and the first and second client terminals 44, 46. The pending order message is used to represent the associated trade order for matching purposes, and is temporarily retained in a memory location of at least one of the IOM function 100 and the external host 14. As a result, a pending trade order may be represented by one pending order message and one or more identical copies of the pending order message. The contents of information fields of the pending order message and copy(s) of the pending order message are overwritten as status updates are provided.

More specifically, upon initialization, the IOM function 100 is configured to register with the provider server 58. Registration notifies the provider server 58 of the identity of the pre-selected group of traders. Registration also notifies the provider server 58 that subsequent IOM-controlled order messages be first routed to the IOM function 100 for matching, rather than to the external host system 12. In addition, during the registration process, the IOM function 100 retrieves copies, from the provider server 58, of all IOM-generated order messages and IOM-controlled order messages, representing pending trade orders originated by the pre-selected group of traders. The IOM function 100 also retrieves copies of all order messages associated with pending trade orders at the exchange from the provider server 58. The IOM function 100 further requests receipt from the provider server 58 of all status updates to the order messages associated with pending trade orders (e.g., IOM-generated order messages) and order messages associated with subsequent trade orders originated by the pre-selected group of traders.

As noted above, trade orders that do not originate from the pre-selected group of traders will not be routed to the IOM function 100, and will instead be matched only by the external host system 12 using the prior art methods. Conversely, trade orders originated by the pre-selected group of traders are forwarded from the client terminal 44 and/or 46 to the provider server 58 and matched as described in connection with a number of exemplary trade order matching scenarios described below. It should be understood however that each of the exemplary trade order matching scenarios are one of a number of possible trade order matching scenarios utilizing the IOM function 100, without departing from the true spirit, central characteristics and scope of the invention.

For ease of understanding, a Scenario #1 is set forth to describe a “no internal match” example, a Scenario #2 is set forth to describe a “full internal match” example, a Scenario #3 is set forth to describe a “partial internal match” example, and a Scenario #4 is set forth to describe a series of matching steps associated with an internal quote generated by the IOM function 100. A number of different outcomes are possible within each of the four scenarios and some of the different outcomes overlap between the four scenarios. In addition, in the four scenarios set forth below, each trade order originated by a trader of the pre-selected group of traders will be referred to in terms of first, second, third, etc., order messages.

Scenario #1—No Internal Match: The IOM Function 100 is Unable to Match a Trade Order to an Internal Quote (or to Another Trade Order)

A first trade order is routed to the provider server 58 as a first order message where (1) it is assigned a first internal identifier via the internal identifier field 201 to form a first internally identified order message 300. As described below, as more trade orders are originated by the pre-selected group of traders, different internal identifiers are generated and assigned to their associated order messages to form additional internally identified order messages.

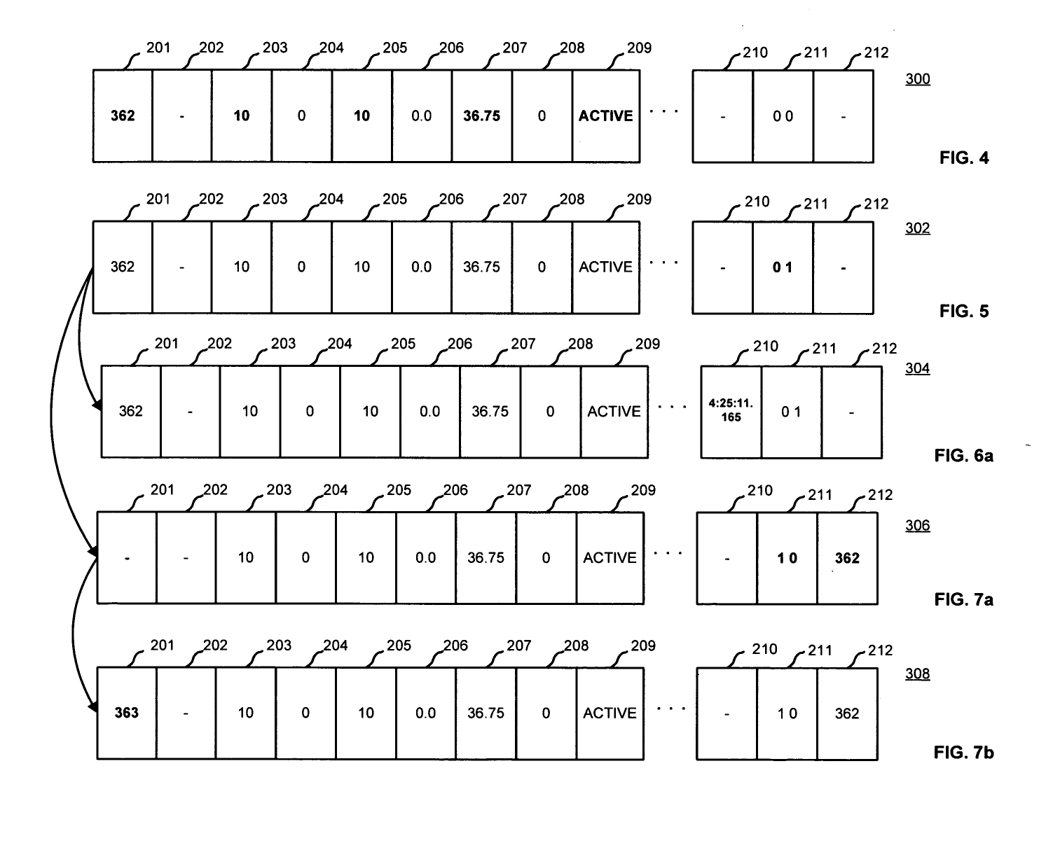

A number of fields of the first internally identified order message 300 include numerical values while others, as yet unused, include initialization values (e.g., empty character string, zero integer value, zero point zero double/float value). For example and referring to FIG. 4, the internal identifier field 201 may indicate a first internal identifier of 362, the total quantity field 203 may indicate a total buy order quantity of 10, the matched order quantity field 204 will indicate a no matched order quantity, the open quantity field 205 may indicate an open quantity of 10, the averaged matched price field 206 will indicate no price, the trade order limit price field 207 may indicate a maximum price limit of 36.75 for the trade order, the order state field 208 will a indicate a zero state for the trade order, the desired order state field 209 will indicate a desired trade order state of active and the time stamp field 210 will indicate no time stamp.

Next, a first indication is enabled in the first internally identified order message 300 via a right-most bit of the flag field 211 (e.g., a first flag is set) to form a first IOM-controlled order message 302, as illustrated in FIG. 5. Enabling the first indication signifies that the IOM function 100, rather than the provider server 58, will maintain subsequent control of the first internally identified order message, currently represented by the first IOM-controlled order message 302.

After forming the first IOM-controlled order message 302, the provider server 58 (3) sends a copy of the first IOM-controlled order message to the trade order database 72 and the client terminals 44, 46. The provider server 58 also retains a copy of the first IOM-controlled order message in a memory location of the provider server 58. The provider server 58 (4) then routes the first IOM-controlled order message 302 to the IOM function 100, thereby relinquishing control of the first IOM-controlled order message 302.

When received by the IOM function 100, the first IOM-controlled order message 302 is added to the internal trade order book 102. The IOM function 100 evaluates and compares the contents of the first IOM-controlled order message 302 to one or more IOM-generated quote messages (see, FIG. 19). In some cases, depending on the embodiment of the invention, the IOM function 100 may compare the contents of the first IOM-controlled order message 302 to copies of other IOM-controlled order messages representative of other pending trade orders originated by the pre-selected group of traders. In those cases, each of the copies of other IOM-controlled order messages is linked to an associated copy of an IOM-generated order message that is retained in a memory location of the IOM function 100, and is representative of an IOM-generated order message listed in the external trade order book.

If, upon comparing the first IOM-controlled order message 302 to the IOM-generated quote message (and/or to copies of other IOM-controlled order messages), the IOM function 100 determines that no match (fill) is possible, the IOM function 100 creates a time-stamped copy of the first IOM-controlled order message 304 which it retains in its internal trade order book 102 after adding the time-stamp in the timestamp field 210 (see, FIG. 6a). The IOM function 100 then disables the first indication and enables a second indication in the flag field 211, removes the first internal identifier from the internal identifier field 201, and inserts the first internal identifier (e.g., 362) in the internal identifier field 201 of the of the first IOM-controlled order message 302 into the linked ID field 212 to form a first IOM-generated order message 306 (see, FIG. 7a). The second indication in the flag field 211 signifies that the first IOM-generated order message 306 was generated by the IOM function 100 as a result of an inability to find an internal quote (and/or a trade order) that met or exceeded a desired trade order price of the first trade order represented by the first IOM-controlled order message 302.

The IOM function 100 routes the first IOM-generated order message 306 to the provider server 58. The provider server 58 recognizes the first IOM-generated order message 306 as an order message representing a trade order, except that the provider server 58 will note the second indication and refrain from forwarding the first IOM-generated order message 306 to the IOM function 100 for internal matching.

When received by the provider server 58, the first IOM-generated order message 306 is assigned a second internal identifier via its internal identifier field 201 (e.g., 363) to form a first pending order message 308, as illustrated in FIG. 7b. The first pending order message 308 is identical to the first internally identified order message 300 except that it includes a different internal identifier, the second indication (i.e., a flag indication an IOM-generated message) and the internal identifier of the first internally identified order message in its linked ID field 211 (e.g., 363).

After forming the first pending order message 308, the provider server 58 sends a copy of the first pending order message to the trade order database 72, the IOM function 100, and to the client terminals 44, 46. In response, the IOM function 100 updates a copy of the first IOM-generated order message with the second internal identifier (e.g., 363). The IOM function 100 also inserts the second internal identifier of the first pending order message 308 (e.g., 363) into the linked ID field 212 of the time-stamped copy of the first IOM-controlled order message 304 to form a linked time-stamped copy of the first IOM-controlled order message 310 (see, FIG. 6b).

Thus, while not listed in the internal trade order book 102, the copy of the first IOM-generated order message, including the second internal identifier of 363, is retained in a memory location of the IOM function 100, and is linked to its associated time-stamped copy of the first IOM-controlled order message 310 held in the internal trade order book 102. Subsequent updates (delivered as order messages) to the first IOM-generated order message 302, for example, the copy of the first pending order messages, are used by the IOM function 100 to update the linked time-stamped copy of the first IOM-controlled order message 310.

A copy of the first pending order message is retained by the provider server 58. The provider server 58 then routes the first pending order message 308 to the external host system 12. Subsequent updates to the first pending order message 308 will be reflected in the information fields of the associated copy of the first pending order message(s) in the provider server 58, the trade order database 72, the IOM function 100, and/or the client terminals 44, 46.

Upon receipt by the external host system 12, the first pending order message 308 is assigned a first external identifier, for example, 1.480, via the external identifier field 202, thereby identifying the first pending order message as an order message listed in the external trade order book of the external host system 12. A copy of the first pending order message, including its first external identifier is routed to the provider server 58 to acknowledge successful receipt of the first pending order message 308. The provider server 58 then forwards a copy of the first pending order message 308, including its first external identifier to the trade order database 72, the IOM function 100, and to the client terminals 44, 46. In response, the IOM function 100 updates the copy of the first IOM-generated message by adding the first external identifier of the first pending order message (e.g., 1480) to the external ID field 202 of the copy of the first IOM-generated order message, the copy being linked to the time-stamped copy of the first IOM-controlled order message 310.

Next the first pending order message 308, now including the external ID, is evaluated and compared to other order messages representative of other pending trade orders originated by both external traders and, in some cases, the pre-selected group of traders. A number of fields of the first pending order message are then modified to reflect a full external match, a partial external match or no external match by the external host system 12.

FIG. 8 illustrates an example of a full external match of the first pending order message 308 to another order message, forming a first matched trade order 312. When the first pending order message is fully matched to form the first matched trade order 312, the internal identifier field 201 continues to indicate the second internal identifier of 363, the external identifier field 202 continues to indicate the first external identifier of 1,480, the total quantity field 203 continues to indicate a total buy order quantity of 10, the matched order quantity field 204 indicates a matched order quantity of 10, the open quantity field 205 indicates an open quantity of zero, the averaged matched price field 206 may indicate a price of 36.72, the trade order limit price field 207 continues to indicate a maximum price limit of 36.75, the order state field 208 indicates a current state of completed, the desired order state field 209 indicates a zero state, and the time stamp field 210 indicates a clock time at which the first pending order message was processed by the external host system 12, for example, the time stamp field may indicate a time of 4:25:11.184. The processing includes updating the external trade order book of all order messages representing trade orders originated by both external traders and, in some cases, the pre-selected group of traders. The updates include whether a trade order has been fully matched, partially matched or not matched by the external host system 12. Thus, in this case, the time stamp field 210 of the first matched trade order 312 indicates a time when the trade order represented by the first pending order message 308 was fully matched to another pending trade order at the external host system 12.

FIG. 9 illustrates an example of no external match of the first pending order message 308 to another order message, forming an updated first pending order message 314. In the updated first pending order message 314 the internal identifier field 201 continues to indicate the second internal identifier of 363, the external identifier field 202 indicates the first external identifier of 1.480, the total quantity field 203 continues to indicate a total buy order quantity of 10, the matched order quantity field 204 continues to indicate a matched order quantity of zero, the open quantity field 205 continues to indicate an open quantity of 10, the averaged matched price field 206 continues to indicate a price of zero, the trade order limit price field 207 continues to indicate a maximum price limit of 36.75, the order state field 208 indicates a current state of active, the desired order state field 209 indicates a desired state of zero, and the time stamp field 210 indicates a time of 4:25:11.184. Thus, in this case, the time stamp field 210 indicates a time that a determination was made that the trade order represented by the first pending order message 308 could not be matched to another pending trade order at the external host system 12.

FIG. 10 illustrates an example of a partial external match of the first pending order message 308 to another order message, forming a first partially matched trade order message 316. In the first partially matched trade order message 316, the internal identifier field 201 continues to indicate the second internal identifier of 363, the external identifier field 202 indicates the first external identifier of 1,480, the total quantity field 203 continues to indicate a total buy order quantity of 10, the matched order quantity field 204 indicates a partial match, for example a matched order quantity of 6, the open quantity field 205 therefore indicates an open quantity of 4, the averaged matched price field 206 indicate a price of 36.72, the trade order limit price field 207 continues to indicate a maximum price limit of 36.75 for the trade order, the order state field 208 indicates a current state of active, the desired order state field 209 indicates a desired state of zero, and the time stamp field 210 indicates a time of 4:25:11.184. Thus, in this case, the time stamp field 210 indicates a time when the trade order represented by the first pending order message was partially matched to another pending trade order at the external host system 12.

Upon determining whether the trade order represented by the first pending order message 308 was fully externally matched or partially externally matched to another pending trade order, the external host system 12 updates the appropriate fields of the first pending order message 308 to form the first matched trade order message 312 or the first partially matched trade order message 314, respectively, and then routes a copy of the first matched trade order message or a copy of the first partially matched trade order message to the provider server 58. If the trade order represented by the first pending order message 308 was not externally matched to another pending trade order, the external host system 12 updates the appropriate fields of the first pending order message as discussed above to form the updated first pending order message 314 and then routes a copy of the updated first pending order message to the provider server 58.

Upon receipt of one of the copy of the first matched trade order message, the copy of the first partially matched trade order message, or the copy of the updated first pending message, the provider server 58 sends the copy to the trade order database 72, the IOM function 100, and the client terminals 44, 46. The copy is used to update the information fields of respective copies of the order messages. For example, in the case of a first partially matched trade order message 316, IOM function 100 updates the copy of the first IOM-generated order message including the matched quantity field 204, the open quantity field 205, the matched price field 206, the order state field 208, and the desired order state field 209. The IOM function 100 also updates the time-stamp field 210 of the linked time-stamped copy of the first IOM-controlled order message 310. A new time-stamp in the time-stamp field 210 reflects the time that the external host 12 partially matched the first pending order message to another order message (see, FIG. 13).

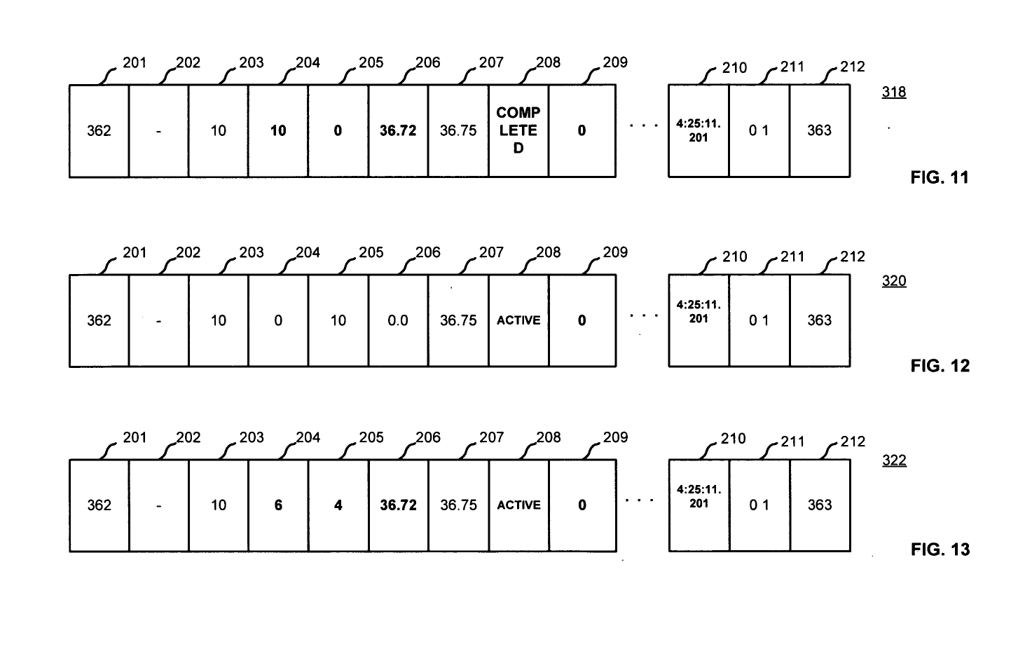

As noted above, in some cases, previous versions of an order message are overwritten by a later version(s) of the order message, causing some of the information fields to change. In those cases, the previous version and the later version of the order message share the same internal identifier (e.g., 362). For example, FIG. 11 is an example of the linked time-stamped copy of the first IOM-controlled order message 310 (see, 6b) updated by the IOM function 100 with information contained in the copy of the first matched trade order message of FIG. 8 reflecting the full match. Similarly, FIG. 12 is an example of the linked time-stamped copy of the first IOM-controlled order message 310 updated by the IOM function 100 with information contained in the copy of the updated first pending order message of FIG. 9 reflecting no match, and FIG. 13 is an example of the linked time-stamped copy of the first IOM-controlled order message 310 updated by the IOM function 100 with information contained in the copy of the first partially matched trade order message of FIG. 10 reflecting the partial match.

After updating the linked time-stamped copy of the first IOM-controlled order message 310 with the copy of the first matched trade order message, the copy of the first partially matched trade order message, or the copy of the updated first pending message (see, FIGS. 11-13), the IOM function 100 forms an updated first IOM-controlled order message, and then sends a copy of the updated first IOM-controlled order message to the provider server 58. As before, the provider server 58 sends a copy of the updated first IOM-controlled order message to the trade order database 72 and the client terminals 44, 46.

Thus, in the case of a full match of the first trade order by the external host system 12 as described in connection with FIG. 8, notification of the full match in the form of a copy of the first matched trade order message is provided to the provider server 58, and then to the IOM function 100, the trade order database 58 and the client terminals 44, 46.

In the case of a partial match of the first trade order by the external host system 12 as described in connection with FIG. 10, notification of the partial match in the form of a copy of the first partially matched trade order message is provided to the provider server 58, and then to the IOM function 100, the trade order database 58 and the client terminals 44, 46. The IOM function 100 updates the first IOM-generated order message 306 and its counterpart, the linked time-stamped copy of the first IOM-controlled order message 310 (held in the internal trade order book), accordingly. Subsequent updates in the form of copies of additional copies of trade order messages from the external host system 12 are similarly used to update.

In the case of no match of the first trade order by the external host system 12 as described in connection with FIG. 9, notification of the no match in the form of a copy of the updated first IOM-controlled order message is provided to the provider server 58, and then to the IOM function 100, the trade order database 58 and the client terminals 44, 46. The IOM function 100 updates the first IOM-generated order message 306 and its counterpart, the linked time-stamped copy of the first IOM-controlled order message 310, accordingly. The updates continue until a full external match of the first trade order is completed.

In some cases depending on the embodiment of the invention, the updates continue until the IOM function 100 identifies a match of the first trade order to a “new” IOM-controlled order message (described in detail below). In those cases, if the IOM function 100 identifies a match of the first trade order to a “new” IOM-controlled order message, the IOM function 100 causes the associated first pending order message to be deleted at the external host system 12 and then enables an internal match between the first trade order and the trade order represented by the new IOM-controlled order message. The linked and time-stamped first IOM-controlled order message is updated accordingly.

During the time the first trade order remains unmatched to another trade order, the trader may be able to (attempt to) delete the first trade order completely or edit/change the first trade order. During this time period, the IOM function 100 may also be able to (attempt to) delete the first trade order completely or change (e.g., change the open quantity field) of the first trade order, as discussed below.

Scenario #2—Full Internal Match: the IOM Function 100 Fully Matches the First Trade Order after it was Unmatched by the IOM Function 100 and then Routed to the External Host System 12

As described in connection with FIGS. 4 through 8, when an IOM-controlled trade order cannot be internally matched, the IOM function 100 creates a copy of the associated IOM-controlled order message. The IOM function 100 further removes the internal identifier, disables the first indication, and enables the second indication in the IOM-controlled order message to form an IOM-generated order message that is linked to the copy of the associated IOM-controlled order message. The IOM-generated order message is routed to the provider server 58 where it is assigned a new internal identifier to form a pending order message (see, FIG. 8). A copy of the pending order message is provided to the IOM function 100, the trade order database 72 and the client terminals 44, 46. The pending order message is then routed to the external host system 12 where it is assigned an external identifier. The trade order represented by the pending order message remains at the external host system 12 until it is executed, deleted via the IOM function 100 or cancelled by the external host system 12. Thus, it is likely that a number of pending order messages resulting from IOM-generated order messages may be awaiting a match at the external host system 12 at any given time.

In the embodiment of Scenario #2, it is assumed that one of the pending order messages at the external host system 12 is derived from an IOM-generated order message that resulted from a previously unmatched trade order originated by one of the pre-selected group of traders. It is also assumed that, once routed to the external host system 12, subsequent internal matching of such pending order messages by the IOM function 100 is desired. For ease of discussion, such a pending order message at the external host system 12 may be the first pending order message 314 as shown in FIG. 9, derived as discussed in connection with FIGS. 4, 5, 7a, 7b and 10. As described above, a copy of the first pending order message of FIG. 7b, linked to the time-stamped first IOM-controlled order message of FIG. 6b, is retained in a memory location of the IOM function 100.

Internal matching by the IOM function 100 of a second trade order with the first trade order at the external host system 12 may be described as follows:

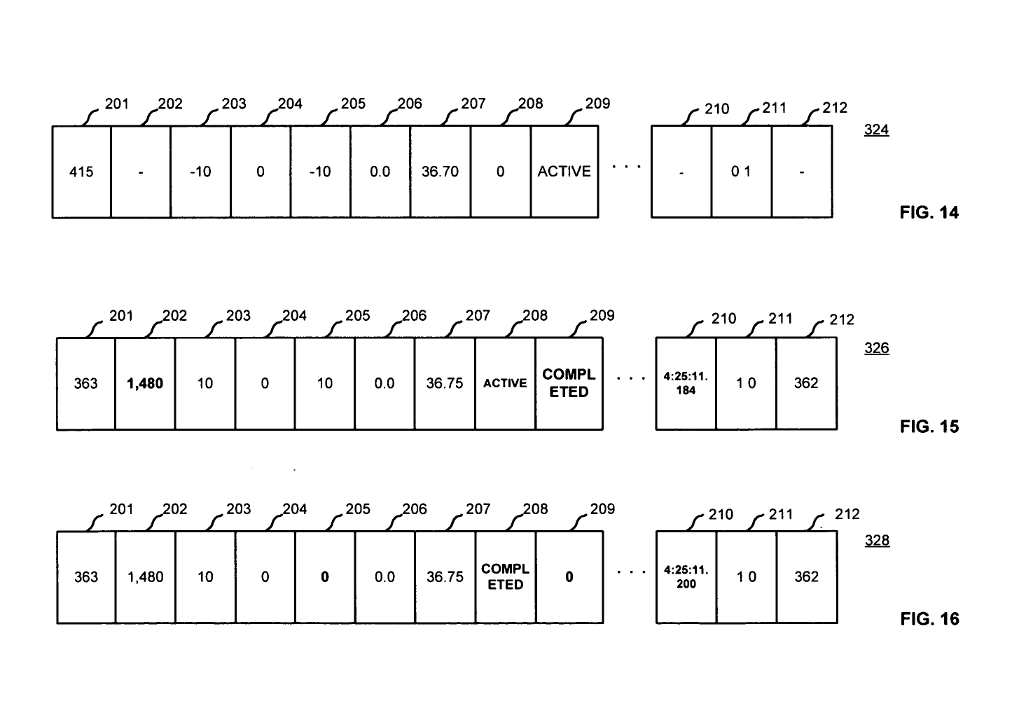

A second trade order is routed to the provider server 58, represented as a second order message where (1) it is assigned a first internal identifier via the internal identifier field 201 to form a second internally identified order message, and where the first indication is enabled to form a second IOM-controlled order message. For example, assuming the second internally identified order message is configured as a second IOM-controlled order message 324 in FIG. 14. In the example, the internal identifier field 201 indicates a first internal identifier of 415, the total quantity field 203 indicates a total sell order quantity of 10, the matched order quantity field 204 indicates a no matched order quantity, the open quantity field 205 indicates an open quantity of −10, the averaged matched price field 206 indicates no price, the trade order limit price field 207 indicates a minimum price limit of 36.70 for the trade order, the order state field 208 indicates a zero state for the trade order, the desired order state field 209 indicates a desired trade order state of active and the time stamp field 210 indicates no time stamp.

After forming the second IOM-controlled order message 324, the provider server 58 sends a copy of the second IOM-controlled order message to each of the trade order database 72 and the client terminals 44, 46. The provider server 58 also retains a copy of the second IOM-controlled order message. The provider server 58 then routes the second IOM-controlled order message 324 to the IOM function 100, where it entered into the internal trade order book 102. The IOM function 100 evaluates and compares the contents of the second IOM-controlled order message 324 to the IOM-generated quote message and/or copies of other IOM-controlled order messages representative of other pending trade orders originated by the pre-selected group of traders. As described above, copies of other IOM-controlled order messages are also retained into the internal trade order book 102, most of which are linked to a copy of a counterpart IOM-generated order message.

Assuming that based on the comparison of the contents of the second IOM-controlled order message 324 to the IOM-generated quote message and/or copies of other IOM-controlled order messages, the IOM function 100 determines that a full match exists between the second IOM-controlled order message of FIG. 14 and the linked time-stamped copy of the first IOM-controlled order message 310 of FIG. 6b. Using the linked ID field 212, the IOM function 100 identifies the first pending order message 308 of FIG. 7b at the external host system 12.

In order to utilize the first pending order message 308 for the full internal match, the IOM function 100 generates a copy of the first pending order message retained in the appropriate memory location, and modifies the desired order state field 209 from “active” to “completed” in the copy to form a deletion order message 326 (see, FIG. 15). A copy of the deletion order message is retained by the IOM function 100. The deletion order message 326 is routed to the provider server 58 where a copy of the deletion order message is retained by the provider server 58 and routed to the trade order database 72 and the client terminals 44, 46. The deletion order message 326 is then routed to the external host system 12.

Upon receipt of the deletion order message 326, the external host system 12 confirms successful deletion of the first pending order message 308 via modifying the open quantity field 205, the order state field 208, the desired order state field 209 and the time stamp field 210 to form a deleted first pending order message 328 as shown in FIG. 16. The deleted first pending order message 328 is routed from the external host system 12 to the provider server 58. Upon receipt, the provider server 58 sends a copy of the deleted first pending order message to trade order database 72 and the client terminals 44, 46, and routes the deleted first pending order message 328 to the IOM function 100.

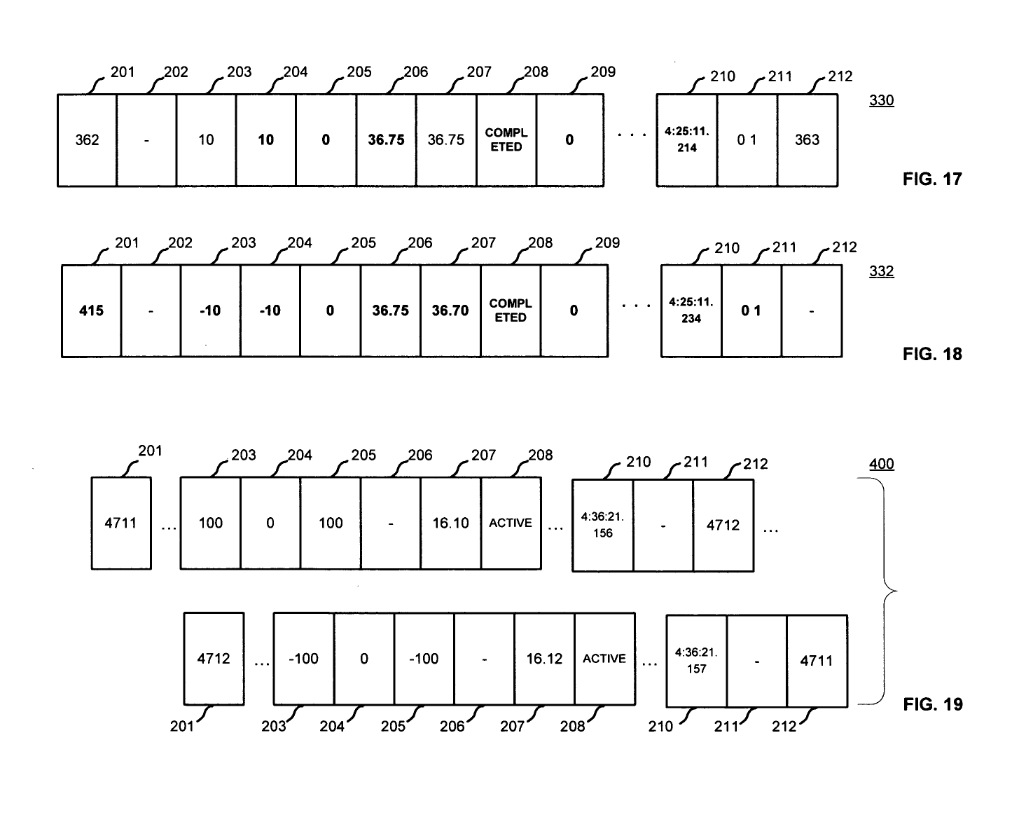

Upon receipt of the deleted first pending order message 328, indicating an open quantity of zero and an order state of completed, the IOM function 100 executes the full match between the buy order indicated in the linked time-stamped copy of the first IOM-controlled order message 310 (updated to reflect no external match) and the sell order indicated in the second IOM-controlled order message 324. FIG. 17 is a matched first IOM-controlled order message 330 illustrating the internally matched buy order indicated in linked time-stamped copy of the first IOM-controlled order message 310. FIG. 18 is a matched second IOM-controlled order message 332 illustrating the internally matched sell order indicated by the second IOM-controlled order message 324, executed by the IOM function 100. The match price for the linked time-stamped copy of the first IOM-controlled order message 310 and the second IOM-controlled order message 324 will be determined from the order price field 207 of linked time-stamped copy of the first IOM-controlled order message 310.

The IOM function 100 retains the first and the matched second IOM-controlled order messages, and sends a copy of the first and the matched second IOM-controlled order messages to the provider server 58. The provider server 58 retains a copy of the first and the matched second IOM-controlled order messages and sends a copy of the first and the matched second IOM-controlled order messages to the trade order database 72 and the client terminals 44, 46.

Scenario #3—Partial Internal Match: The IOM function 100 Partially Matches the First Trade Order after it was Unmatched by the IOM Function 100 and then Routed to the External Host System 12

In some cases, the IOM function 100 may determine that an incoming IOM-controlled order message may be partially matched with the first pending order message 308 at the external host system 12 The matched portion of the trade order is executed as described in connection with FIGS. 14-18, while the unmatched portion is executed as described in connection with FIGS. 4-13.

In some cases, it may not be desirable to “pull” unmatched trade orders originated by the pre-selected group of traders, from the external host system 12. For such cases, the market maker, or equivalent, has a “quote-only” option to select whether trade orders are to be internally matched by the IOM function 100 exclusively with IOM-generated quotes upon order entry. This option precludes the matching of a trade order originated by a pre-selected trader with another trade order originated by another pre-selected trader. Accordingly, this option precludes deletion of pending trade orders at the external host system 12, where the pending trade orders were originated by any of the pre-selected group of traders and were unable to be fully internally matched by the IOM function 100. In other words, selecting this option prevents a trade order, originated by one of the pre-selected group of traders, from being pulled from the external host system 12, even if it can be internally matched by the IOM function 100 with a subsequent IOM-generated quote. The quote-only option is enabled by a system administrator via a configuration parameter setting prior to operation of the IOM function 100.

Scenario #4—Internal Quote: the IOM Function 100 Matches a Series of IOM-Controlled Order Messages with an IOM-Generated Quote Message

As described above, the IOM function 100 may be configured to generate IOM-generated quote messages based on predefined parameters and selected values for those predefined parameters, where the predefined parameters and selected values are determined by a market maker (or equivalent). The predefined parameters may include price parameters, quantity parameters including a refill quantity parameter, and security parameters (e.g., max traded quantity, max position, max long position, max short position, max long value, max short value).

In cases where an IOM-generated quote message has been generated by the IOM function 100, the contents of each individual IOM-controlled order message are compared to the IOM-generated quote message (and in some embodiments, to copies of other IOM-controlled order messages as described above). If one or more security parameters are selected and assigned an associated numerical value, the IOM function 100 additionally monitors associated current numerical values for comparison to the stipulated security function numerical value.

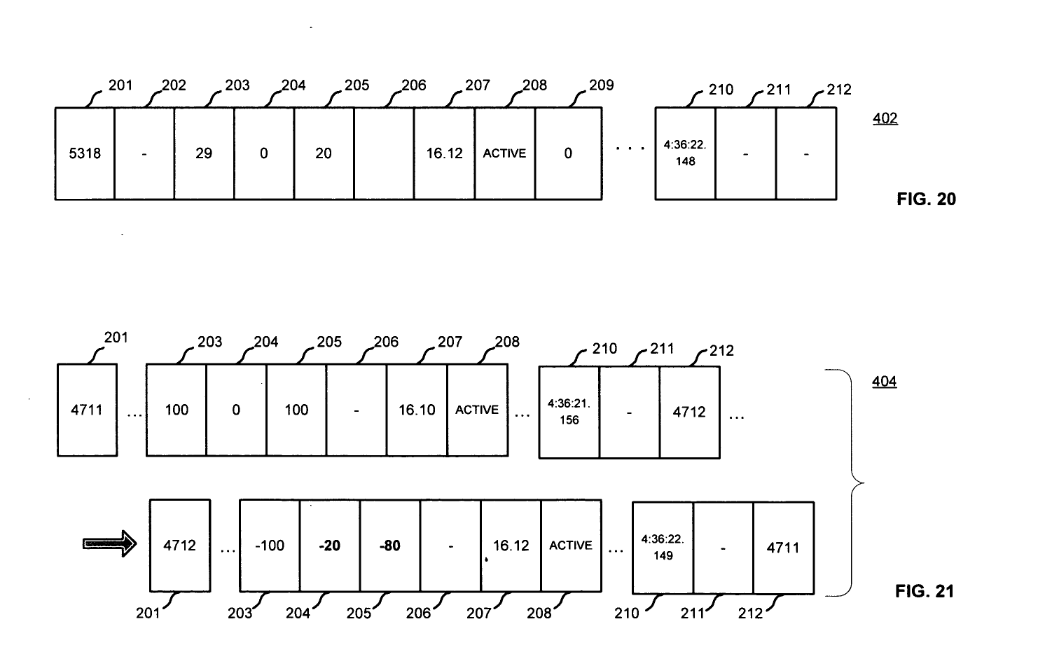

For example, FIG. 19 is an exemplary IOM-generated quote message 400, according to an embodiment of the invention, and FIG. 20 is an exemplary (buy) order message 402 resulting from a third trade order originated by a trader of the pre-selected group of traders. The IOM-generated quote message 400 includes a buy side with a quantity of 100 @ 16.10 having an internal identifier of 4711, and a sell side with the quantity −100 @ 16.12 having an internal identifier of 4712, where the buy side and sell side are linked to each other via their respective linked ID fields 212. The external ID fields 202 and the desired order state fields 209 are not required for the IOM-generated quote message as the IOM-generated quote message is never forwarded to the external host system 12. The flag field 211 of each of the buy side and sell side of the IOM-generated quote include both the first indication and the second indication; in this case, both are set to 1. The time stamp of 4:36:21.156 and 4:36:21.157 indicates the time of generation of the buy side and sell side of the IOM-generated quote message 400, respectively.

The third IOM-controlled order message 402 includes an order to buy a quantity of 20 @ 16.12, and when received by the IOM function 100, can be fully matched to a portion of the sell side of the IOM-generated quote message 400. The time stamp of 4:36:22.148 in FIG. 20 indicates a time that the third IOM-controlled order message 402 was matched by the IOM function 100. FIG. 21 is an IOM-generated quote message 404 reflecting an internal match between the IOM-generated quote message 400 and the third IOM-controlled order message 402. In the IOM-generated quote message 404, the buy side continues to reflect the quantity of 100 @ 16.10, while the sell side reflects a remaining quantity of quantity −80 @ 16.12. The updated timestamp of 4:36:22.149 indicates a time that the IOM function 100 matched the IOM-generated quote message 400 with the third IOM-controlled order message 402.

If the market maker selects the quote-only option described above in connection with Scenario #2, a trade order originated by a trader of the pre-selected group of traders (and previously unmatched by the IOM function 100), is not deleted from the external host system 12, even in a case where an IOM-generated quote can be matched with such a trade order. For example, FIG. 22 is an exemplary (buy) order message resulting from a fourth trade order originated by a trader of the pre-selected group of traders, hereinafter referred to as a fourth IOM-controller order message 406. The fourth IOM-controlled order message 406 includes an order to buy a quantity of 20 @ 16.10. Assuming the concurrent existence of the IOM-generated quote message 400 (where the buy side has the quantity of 100 @ 16.10, and the sell side has the quantity of −100 @ 16.12), upon receipt of the fourth IOM-controlled order message 406, the IOM function 100 determines that the associated order to buy a quantity of 20 @ 16.10 cannot be internally matched to a portion of the sell side of the IOM-generated quote message 400. As a result, a pending order message associated with the fourth IOM-controlled order message 406 is subsequently routed to the external host system 12 for external matching.

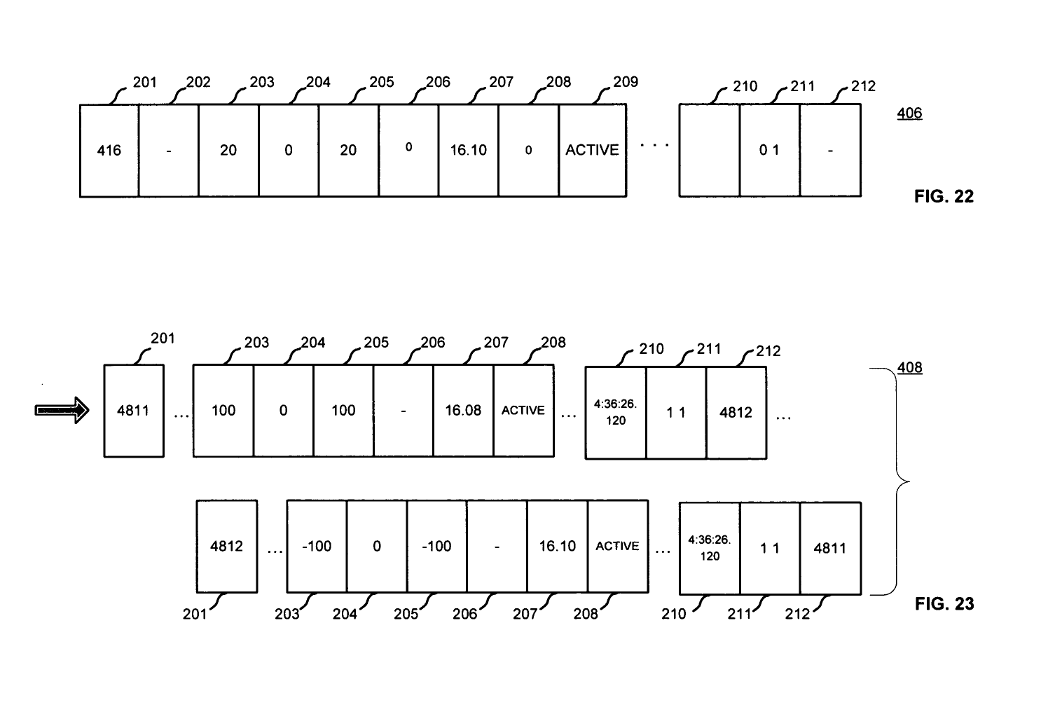

Because the quote-only option was selected, the pending order message associated with the fourth IOM-controlled order message 406 will remain at the external host system 12 until it is externally matched. For example, FIG. 23 is another IOM-generated quote message 408 which includes a buy side with a quantity of 100 @ 16.08 having an internal identifier of 4811, and a sell side with the quantity −100 @ 16.10 having an internal identifier of 4812. Referring again to FIG. 22, the order to buy a quantity of 20 @ 16.10 could be matched to the sell side of the IOM-generated quote message 408 with the quantity −100 @ 16.10. Because the quote-only option was selected however, the match between the fourth IOM-controlled order message 406 and the IOM-generated quote message 408 will not be made by the IOM function 100; rather, the external host system 12 will facilitate the match.

Referring again to FIG. 19, if a security parameter has been selected and a value stipulated, in addition to updating the information fields of an IOM-generated quote message and an associated IOM-controlled order message, the IOM function 100 will update the current value for the security parameter. For example, using the IOM-generated quote message 400 and the third IOM-controlled order message 402, if a maximum position of 250 was selected by the market maker, the IOM function 100 will note the current position of the tradable instrument on both the buy and sell side, and compare it to the maximum position range of −250 to 250. If the current position on the buy and/or sell side is greater than 250 or less that −250, the IOM function 100 changes the ‘active’ indication to a ‘stop’ indication in the respective order state field 208. In this way, the buy and/or sell side of the IOM-generated quote message 400 is prevented from being subsequently matched to exceed the maximum position of 250. For example, if the current position was 221 prior to the internal match between the third IOM-controlled order message 402 with a buy-quantity of 20 and the IOM-generated quote message 400 with a sell-quantity of −20, the current position after the internal match is 201.

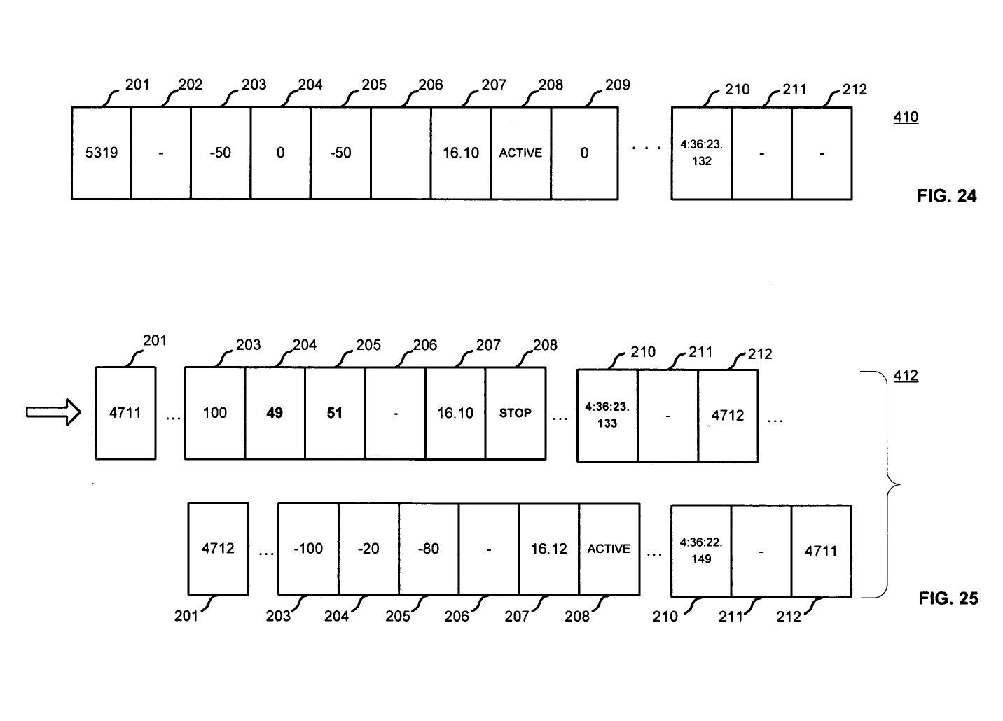

Continuing with the example, FIG. 24 is a fifth IOM-controlled order message 410 resulting from a fifth trade order originated by a trader of the pre-selected group of traders. The fifth IOM-controlled order message 410 includes an order to sell a quantity of −50 @ 16.10, and when received by the IOM function 100, can be partially matched to the buy side of the IOM-generated quote message 404 of FIG. 21. FIG. 25 is the IOM-generated quote message 404 of FIG. 21, updated to reflect a partial internal match with the fifth IOM-controlled order message 410. Because the maximum position was stipulated as 250, only 49 of the 50 quantity of the fifth IOM-controlled order message 410 is able to be internally matched to the IOM-generated quote message 404, and the order state field 208 of the buy side of the IOM-generated quote message 404 is changed from an active state to a stop state. The unmatched remainder quantity of 1 of the fifth IOM-controlled order message 410 is subsequently sent to the external host system 12 for matching as described in connection with FIGS. 5-13. As a result, the buy side of the IOM-generated quote message 400 reflects a remaining quantity of 51 @ 16.10, while the sell side continues to reflect the quantity −80 @ 16.12. The updated timestamp of 4:36:23.133 indicates a time that the IOM function 100 matched the IOM-generated quote message 404 with the fifth IOM-controlled order message 410.

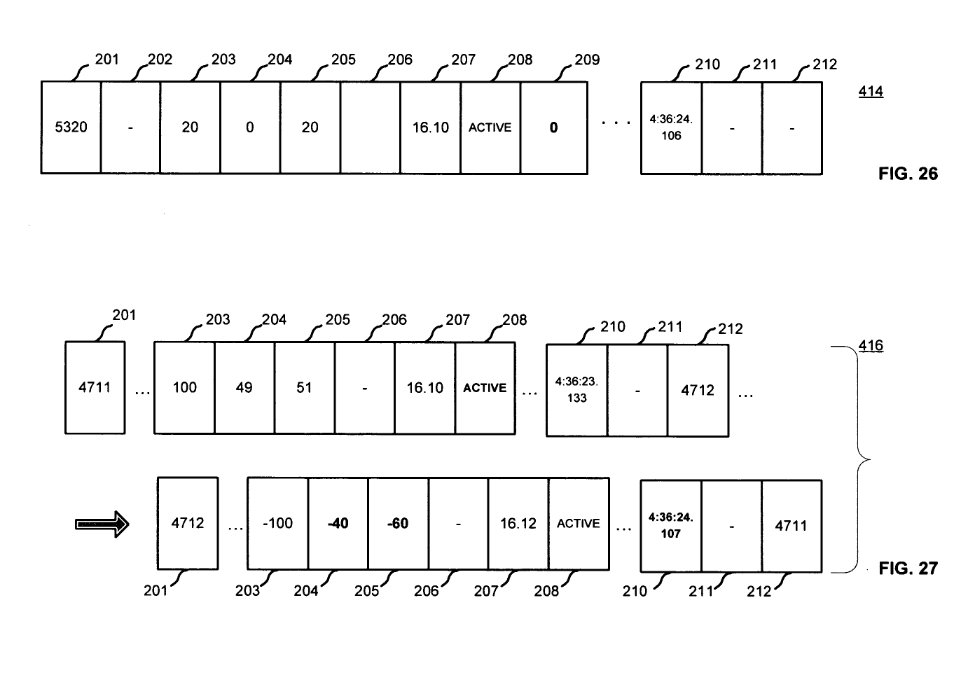

FIG. 26 is a sixth (buy) IOM-controlled order message 414 resulting from a sixth trade order originated by a trader of the pre-selected group of traders. The sixth IOM-controlled order message 414 includes an order to buy a quantity of 20 @ 16.12, and when received by the IOM function 100, can be fully matched to a portion of the sell side of the IOM-generated quote message 412 of FIG. 25. FIG. 27 is the IOM-generated quote message 412 of FIG. 25, updated to reflect an internal match with the sixth IOM-controlled order message 414. As a result of the match, the IOM function 100 changes the current position of the tradable instrument from 250 to 230, and changes the order state field 208 of the buy side of the IOM-generated quote message from the stop state to the active state. The buy side of the IOM-generated quote message 416 continues to reflect the quantity of 51 @ 16.10, while the sell side reflects a remaining quantity of −60 @ 16.12. The updated timestamp of 4:36:24.107 indicates a time that the IOM function 100 matched the IOM-generated quote message 412 with the sixth IOM-controlled order message 414.

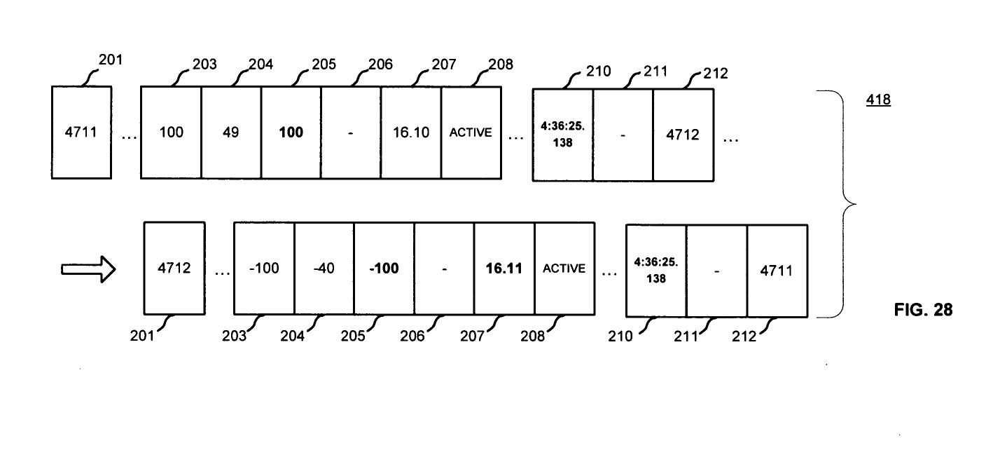

In addition to reflecting a match, the information fields of the IOM-generated quote message may be updated for any number of reasons, such as, for example, reaching a security function limit, receiving changes/updates associated with the reference market (e.g., best bid price changes, best ask price changes), responding to a defined refill quantity parameter. For example, FIG. 28 is the IOM-generated quote message 416 of FIG. 27, updated to reflect a change in the best ask price from 16.12 to 16.11. In the example of FIG. 28, the open trade order quantity fields 205 of the buy and sell side of the IOM-generated quote message are refilled to their original quantity of 100 by the IOM function 100.

While this invention has been described with reference to certain illustrative aspects, it will be understood that this description shall not be construed in a limiting sense. Rather, various changes and modifications can be made to the illustrative embodiments without departing from the true spirit, central characteristics and scope of the invention, including those combinations of features that are individually disclosed or claimed herein. Furthermore, it will be appreciated that any such changes and modifications will be recognized by those skilled in the art as an equivalent to one or more elements of the following claims, and shall be covered by such claims to the fullest extent permitted by law.

The present invention may be implemented as a computer process, a computing system or as an article of manufacture such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

In one embodiment, the logical operations of the present invention are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations making up the embodiments of the present invention described herein are referred to variously as operations, structural devices, acts or modules. It will be recognized by one skilled in the art that these operations, structural devices, acts and modules may be implemented in software, in firmware, in special purpose digital logic, and any combination thereof without deviating from the spirit and scope of the present invention as recited within the claims attached hereto.

What is claimed is:

1. A system for internally matching a plurality of electronic trade orders originated by a pre-selected group of traders, the system comprising:
an internal provider server;
an internal order matcher communicatively coupled to the internal provider server;
a gateway communicatively coupled to the internal provider server and an external host system, the gateway configured to provide a translation interface between the internal provider server and an external host system; and
a client terminal communicatively coupled to the internal provider server, the client terminal enabling origination of a first electronic trade order by a first trader of the pre-selected group of traders,
wherein the internal order matcher is configured to match the first electronic trade order to a second electronic trade order to form a matched electronic trade order.

2. The system of claim 1, wherein the external host system comprises an electronic exchange.

3. The system of claim 1, wherein each of the plurality of electronic trade orders is at least one selected from the group consisting of an order to sell a quantity of a tradable instrument and an order to buy a quantity of the tradable instrument.

4. The system of claim 3, wherein the tradable instrument is at least one selected from the group consisting of an equity, an option, a future, a warrant, a bond, a commodity and a currency.

5. The system of claim 1, wherein the gateway is resident in the external host system.

6. The system of claim 1, wherein the gateway is resident in the internal provider server.

7. The system of claim 1, wherein the second electronic trade order comprises an IOM-generated quote message associated with an internal quote generated based on parameters and associated values selected by a second trader of the pre-selected group of traders.

8. The system of claim 1, wherein the second electronic trade order is originated by a second trader of the pre-selected group of traders.

9. A system for internally matching an electronic trade order originated by a trader of a pre-selected group of traders, the system comprising:
an internal provider server including an internal order matcher function; and
a gateway communicatively coupled to the internal provider server and an external host system, the gateway configured to provide a translation interface between the internal provider server and an external host system,
wherein the internal provider server is configured to match the electronic trade order to another electronic trade order to form a matched electronic trade order.

10. The system of claim 9, wherein the external host system comprises an electronic exchange.

11. The system of claim 9, wherein the electronic trade order is at least one selected from the group consisting of an order to sell a quantity of a tradable instrument and an order to buy a quantity of the tradable instrument.

12. The system of claim 11, wherein the tradable instrument is at least one selected from the group consisting of an equity, an option, a future, a warrant, a bond, a commodity and a currency.

13. The system of claim 9, wherein the gateway is resident in the external host system.

14. The system of claim 9, wherein the gateway is resident in the internal provider server.

15. The system of claim 9, wherein the another electronic trade order comprises an IOM-generated quote message associated with an internal quote generated based on parameters and associated values selected by another trader of the pre-selected group of traders.

16. The system of claim 9, wherein the another electronic trade order is originated by another trader of the pre-selected group of traders.

17. In an internal provider server including an internal order matcher (IOM) function, a method for internally matching at least a first electronic trade order, the internal provider server communicatively coupled to a gateway, the gateway configured to provide a translation interface between the internal provider server and an external host system, the method comprising:
receiving a first order message representing the first electronic trade order, the first electronic trade order is originated via a trader of a pre-selected group of traders;
providing a first internal identifier in an internal identifier field of the first order message;
enabling a first indication in the first internally identified first order message to form a first IOM-controlled order message, the first indication indicating that the first electronic trade order is eligible for internal matching;
comparing the first IOM-controlled order message to a number of entries of an internal order book of the internal provider server, each of the number of entries corresponding to a pending electronic trade order; and
if the first IOM-controlled order message can be matched to one of the entries, internally matching the first electronic trade order to a pending electronic trade order represented by the one of the entries.

18. The method of claim 17, further comprising:
updating the first IOM-controlled order message to reflect the internal match;
sending a first copy of the updated first IOM-controlled order message to an internal database of the internal provider server; and
sending a second copy of the updated first IOM-controlled order message to a client terminal used by the trader to place the first electronic trade order.

19. The method of claim 17, further comprising, if the first IOM-controlled order message can not be matched to one of the entries,
creating a copy of the first IOM-controlled order message;
adding a first time-stamp to the copy of the first IOM-controlled order message to form a first time-stamped copy of the first IOM-controlled order message; and
adding the first time-stamped copy of the first IOM-controlled order message as an additional entry into the internal order book.

20. The method of claim 19, further comprising:
disabling the first indication and enabling a second indication and removing the first internal identifier in the first IOM-controlled order message to form a first IOM-generated order message;
inserting the first internal identifier of the first order message into a linked identity field of the first IOM-generated order message;
providing a second internal identifier in an internal identifier field of the first IOM-generated order message to form a first pending order message;
creating and retaining a copy of the first pending order message in a memory location; and
sending the first pending order message to the external host system.

21. The method of claim 20, further comprising:
inserting the second internal identifier of the first pending order message into a linked identity field of the time-stamped copy of the first IOM-controlled order message, the second identifier linking the time-stamped copy of the first IOM-controlled order message to the copy of the first pending order message to form a linked time-stamped copy of the first IOM-controlled order message.

22. The method of claim 21, further comprising:
causing the first pending order message to be deleted at the external host system if a comparison between a second IOM-controlled order message and the linked time-stamped copy of the first IOM-controlled order message yields a match, the second IOM-controlled order message associated with a second electronic trade order originated by another trader of the pre-selected group of traders; and
internally matching the first electronic trade order with the second electronic trade order upon verification of successful deletion of the first pending order message.

23. The method of claim 17, wherein each of the number of entries of the internal order book is at least one selected from the group consisting of a copy of an external order message associated with an electronic trade order not originated by the pre-selected group of traders, a copy of an order message associated with an electronic trade order originated by a trader of the pre-selected group of traders, and an order message associated with an electronic trade order originated by a trader of the pre-selected group of traders.

24. The method of claim 17, wherein the number of entries further comprise at least one IOM-generated quote message associated with an internal quote generated by the internal provider server based on parameters and associated values selected by a market maker of the pre-selected group of traders.

25. The method of claim 17, wherein the external host system comprises an electronic exchange.

26. The method of claim 17, wherein the first electronic trade order is at least one selected from the group consisting of an order to sell a quantity of a tradable instrument and an order to buy a quantity of the tradable instrument.

27. The method of claim 26, wherein the tradable instrument is at least one selected from the group consisting of an equity, an option, a future, a warrant, a bond, a commodity and a currency.

28. In an internal provider server including an internal order matcher (IOM) function, a method for internally matching at least a first electronic trade order, the internal provider server communicatively coupled to a gateway, the gateway configured to provide a translation interface between the internal provider server and an external host system, the method comprising:
receiving a first order message representing the first electronic trade order, the first electronic trade order placed by a trader of a pre-selected group of traders;
providing a first internal identifier in an internal identifier field of the first order message;
enabling a first indication in the first internally identified first order message to form a first IOM-controlled order message, the first indication indicating that the first electronic trade order is eligible for internal matching;
comparing the first IOM-controlled order message to an IOM-generated quote message associated with an internal quote generated by the internal provider server based on parameters and associated values selected by another trader of the pre-selected group of traders; and
if the first IOM-controlled order message can be matched to the IOM-generated quote message, internally matching the first electronic trade order to the internal quote, the IOM-generated quote message included as at least one of a number of entries of an internal order book of the internal provider server.

29. The method of claim 28, further comprising adjusting at least one field of the IOM-generated quote message to reflect the internal match.

30. The method of claim 28, further comprising:
updating the first IOM-controlled order message to reflect the internal match;
sending a first copy of the updated first IOM-controlled order message to an internal database of the internal provider server; and
sending a second copy of the updated first IOM-controlled order message to a client terminal used by the trader to place the first electronic trade order.

31. The method of claim 28, further comprising, if the first IOM-controlled order message cannot be matched to the IOM-generated quote message,
creating a copy of the first IOM-controlled order message;
adding a first time-stamp to the copy of the first IOM-controlled order message to form a first time-stamped copy of the first IOM-controlled order message; and
adding the first time-stamped copy of the first IOM-controlled order message as an additional entry into the internal order book.

32. The method of claim 31, further comprising:
disabling the first indication and enabling a second indication and removing the first internal identifier in the first IOM-controlled order message to form a first IOM-generated order message;
inserting the first internal identifier of the first order message into a linked identity field of the first IOM-generated order message;
providing a second internal identifier in an internal identifier field of the first IOM-generated order message to form a first pending order message;
creating and retaining a copy of the first pending order message in a memory location; and
sending the first pending order message to the external host system.

33. The method of claim 32, further comprising:
inserting the second internal identifier of the first pending order message into a linked identity field of the time-stamped copy of the first IOM-controlled order message, the second identifier linking the time-stamped copy of the first IOM-controlled order message to the copy of the first pending order message to form a linked time-stamped copy of the first IOM-controlled order message.

34. The method of claim 28, wherein the number of entries of the internal order book includes at least one copy of an external order message associated with an electronic trade order not originated by the pre-selected group of traders.

35. The method of claim 28, wherein the external host system comprises an electronic exchange.

36. The method of claim 28, wherein the first electronic trade order is at least one selected from the group consisting of an order to sell a quantity of a tradable instrument and an order to buy a quantity of the tradable instrument.

37. The method of claim 36, wherein the tradable instrument is at least one selected form the group consisting of an equity, an option, a future, a warrant, a bond, a commodity and a currency.
